(19) United States
(12) Patent Application Publication
(10) Pub. No.: US 2024/0229391 A1
(43) Pub. Date: Jul. 11, 2024

(54) SNOW BLOWER

(71) Applicant: Nanjing Chervon Industry Co., Ltd., Nanjing (CN)

(72) Inventors: Meng Kong, Nanjing (CN); Toshinari Yamaoka, Nanjing (CN); Huixing Fu, Nanjing (CN); Yongqing Fang, Nanjing (CN); Jifeng Feng, Nanjing (CN); Peng Wang, Nanjing (CN); Zengbing Guo, Nanjing (CN)

(21) Appl. No.: 18/617,047

(22) Filed: Mar. 26, 2024

Related U.S. Application Data
(63) Continuation of application No. PCT/CN2023/097723, filed on Jun. 1, 2023.

(30) Foreign Application Priority Data
Jun. 10, 2022 (CN) 202210652331.8
Jun. 10, 2022 (CN) 202210652336.0
Jun. 10, 2022 (CN) 202210652337.5
Jun. 10, 2022 (CN) 202210652679.7
Jun. 10, 2022 (CN) 202210652688.6

(51) Int. Cl. E01H 5/04; E01H 5/09

(52) U.S. Cl. CPC E01H 5/045; E01H 5/098

(57) ABSTRACT

A snow blower includes a body; and an operation assembly connected to the body. The body includes a snow throwing system, and the snow throwing system includes: a snow throwing member; a deflector connected to the snow throwing member and disposed on the snow throwing member; a first motor configured to drive the snow throwing member to rotate relative to the body about a first axis; and a second motor configured to drive the deflector to rotate relative to the snow throwing member about a second axis. When the snow throwing member is at an intermediate position, the first motor and the second motor are each in a first circular region which uses a point on the second axis as a center, and the radius of the first circular region is less than or equal to 800 mm.

### RELATED APPLICATION INFORMATION

This application is a continuation of International Application Number PCT/CN2023/097723, filed on Jun. 1, 2023, through which this application also claims the benefit under 35 U.S.C. § 119(a) of Chinese Patent Application No. 202210652688.6, filed on Jun. 10, 2022, Chinese Patent Application No. 202210652679.7, filed on Jun. 10, 2022, Chinese Patent Application No. 202210652337.5, filed on Jun. 10, 2022, Chinese Patent Application No. 202210652336.0, filed on Jun. 10, 2022, Chinese Patent Application No. 202210652331.8, filed on Jun. 10, 2022, which applications are incorporated herein by reference in their entireties.

### TECHNICAL FIELD

The present application relates to a hand push working machine, for example, a snow blower.

### BACKGROUND

A snow blower is a common power tool for removing snow on the ground. The snow blower has the functions of removing and throwing snow. In a conventional snow blower, multiple electric motors for adjusting a snow throwing system are relatively distant from each other and the wiring among the multiple electric motors is cumbersome. In addition, the multiple electric motors also affect the balance of the center of gravity of the snow throwing system.

### SUMMARY

In an example, a snow blower includes: a body; and an operation assembly connected to the body and configured to allow an operator to guide and control the snow blower. The body includes a snow throwing system, and the snow throwing system includes: a snow throwing member; a deflector connected to the snow throwing member and disposed on the snow throwing member; a first motor configured to drive the snow throwing member to rotate relative to the body about a first axis; and a second motor configured to drive the deflector to rotate relative to the snow throwing member about a second axis. When the snow throwing member is at an intermediate position, the first motor and the second motor are each in a first circular region which uses a point on the second axis as a center, and the radius of the first circular region is less than or equal to 800 mm.

In an example, the body further includes a snow removal housing and a support rod extending substantially along an up and down direction, where one end of the support rod is connected to the snow removal housing and the other end of the support rod is used for supporting the first motor.

In an example, the support rod includes a first rod portion and a second rod portion which constitute a detachable connection, where the first rod portion and the second rod portion are detachably connected to each other so that the snow throwing system is detachable relative to the snow removal housing.

In an example, the first motor and the second motor are each disposed at the upper end of the support rod.

In an example, the body further includes a first transmission mechanism including at least a first gear and a second gear, where the first motor drives the first gear to rotate, the first gear drives the second gear to rotate, and the first gear and the second gear are configured to be bevel gears.

In an example, the first transmission mechanism further includes a first output shaft, where the second gear drives the first output shaft to rotate about the first axis.

In an example, the first output shaft is further connected to a rotating member, where one end of the rotating member is sleeved on the first output shaft and driven by the first output shaft and the other end of the rotating member is fixedly connected to the snow throwing member and is used for driving the snow throwing member to rotate about the first axis.

In an example, the body further comprises a second transmission mechanism including at least a worm gear and a worm shaft, where the second motor drives the worm shaft to drive the worm gear to rotate about the second axis, and the worm gear drives the deflector to rotate about the second axis.

In an example, the distance from the center of gravity of the first motor to the first axis is greater than or equal to 40 mm and less than or equal to 100 mm.

In an example, the second motor is in a second circular region which uses the second axis as a center, where the radius of the second circular region is greater than or equal to 25 mm and less than or equal to 75 mm.

In an example, the body further includes a motor housing, where the first motor and the second motor are disposed in the motor housing, the motor housing includes a first portion, a second portion, and a third portion, and the first portion is fixedly mounted to the deflector.

In an example, the deflector drives the first portion to rotate relative to the second portion about the second axis when the second motor drives the deflector to rotate about the second axis.

In an example, the operation assembly includes at least an operation member configured to control the first motor or the second motor to run, where the operation member is provided with a handle, and a user is capable of operating the handle to rotate in a front and rear direction and a left and right direction so as to control the snow throwing member to rotate about the first axis in the left and right direction and the deflector to rotate about the second axis in an up and down direction.

In an example, the snow blower further includes: an operation member configured to be operated by a user to control the first motor; and a first controller electrically connected to at least the first motor and configured to control the first motor to run. The first controller is configured to control, based on the state of the operation member, the first motor to run to drive the snow throwing member to rotate at a constant speed relative to the body about the first axis.

In an example, the snow blower further includes: an operation member configured to be operated by a user to control the second motor; and a second controller electrically connected to at least the second motor and configured to control the second motor to run. The second controller is configured to: after the second motor is started, control the second motor to run at a constant speed to drive the deflector to rotate relative to the snow throwing member about the second axis.

In an example, a snow blower includes: a body; and an operation assembly connected to the body and configured to allow an operator to guide and control the snow blower. The body includes a snow throwing system, and the snow throwing system includes: a snow throwing member; a deflector connected to the snow throwing member and disposed on the snow throwing member; a first motor configured to drive the snow throwing member to rotate relative to the body about a first axis; a second motor configured to drive the deflector to rotate relative to the snow throwing member about a second axis; and a support rod, where the lower end of the support rod is connected to a snow removal housing, and the upper end of the support rod supports a first motor. The first motor and the second motor are each disposed at the upper end of the support rod.

In an example, the support rod includes a first rod portion and a second rod portion which constitute a detachable connection, where the first rod portion and the second rod portion are detachable so that the snow throwing system is relatively detachable.

In an example, a snow blower includes: a body; and an operation assembly connected to the body and including at least an operation member. The body includes at least: a snow throwing member; a deflector connected to the snow throwing member and disposed on the snow throwing member; a first motor configured to drive the snow throwing member to rotate relative to the body about a first axis; a second motor configured to drive the deflector to rotate relative to the snow throwing member about a second axis; and a first controller electrically connected to at least the first motor and configured to control the first motor to run. The first controller is configured to control, based on the state of the operation member, the first motor to run to drive the snow throwing member to rotate at a constant speed relative to the body about the first axis.

In an example, the snow blower further includes a second controller electrically connected to at least the second motor and configured to control the second motor to run. The second controller is configured to: after the second motor is started, control the second motor to run at a constant speed to drive the deflector to rotate relative to the snow throwing member about the second axis.

In an example, the operation member is provided with a handle, and a user is capable of operating the handle to rotate in a front and rear direction and a left and right direction so as to control the snow throwing member to rotate about the first axis in the left and right direction and the deflector to rotate about the second axis in an up and down direction.

In an example, a hand push working machine includes: a body; an operation assembly connected to the body; a walking wheel group used for supporting the body and including at least wheels; a self-moving motor configured to drive the wheels to rotate; and a transmission mechanism disposed between the self-moving motor and the walking wheel group and used for implementing the transmission between the self-moving motor and the wheels. The transmission mechanism includes: a clutch used for driving the wheels to rotate; and a drive apparatus connected to the clutch and used for driving the clutch to switch between a locked state and an unlocked state. The operation assembly includes a first operation member, where the clutch switches from the locked state to the unlocked state when the first operation member drives the drive apparatus to rotate about a first straight line.

In an example, the drive apparatus is formed with or connected to a connector, where the connector drives at least part of the clutch to move along the direction of the first straight line when the first operation member drives the drive apparatus to rotate about the first straight line.

In an example, no action of a force exists between the clutch and the connector in the direction of the first straight line when the clutch is in the locked state.

In an example, the connector is configured to be a clip, where one end of the clip is fixedly connected to the drive apparatus and the other end of the clip extends into the clutch and forms a clearance fit with the clutch.

In an example, the clutch is formed with a first annular groove, the drive apparatus is formed with a second annular groove, and the first annular groove and the second annular groove form an accommodating space for accommodating the connector.

In an example, the connector is configured to be multiple balls capable of rolling in the accommodating space along the first annular groove or the second annular groove.

In an example, the walking wheel group further includes a walking wheel shaft disposed between the wheels, and the drive apparatus includes a spiral shaft sleeve and a drive member, where the spiral shaft sleeve is sleeved on the walking wheel shaft, the drive member is sleeved on the spiral shaft sleeve, and the drive member is driven by the first operation member.

In an example, the drive apparatus further includes a ball bearing disposed between the drive member and the spiral shaft sleeve, where spiral grooves are formed on the spiral shaft sleeve, the drive member is formed with positioning holes, at least part of the ball bearing is located in the positioning holes, and when the first operation member drives the drive member to rotate about the first straight line, the ball bearing rolls in the spiral grooves.

In an example, the clutch includes a first gear and a second gear, where the first gear is driven by the self-moving motor and the second gear is driven by the first gear, and the clutch further includes an output shaft sleeved on the walking wheel shaft and driven by the second gear to drive the wheels to rotate.

In an example, the first gear is formed with first internal teeth, the second gear is formed with first external teeth and second internal teeth, and the output shaft is formed with or connected to second external teeth, where the first internal teeth mesh with the first external teeth, and the second internal teeth mesh with the second external teeth.

In an example, the first internal teeth mesh with the first external teeth when the clutch is in the locked state, and the first internal teeth are separated from the first external teeth when the clutch is in the unlocked state.

In an example, the drive apparatus further includes a second elastic element disposed at the end of the drive member facing away from the clutch.

In an example, the second elastic element is used for driving the clutch to switch from the unlocked state to the locked state when the first operation member stops driving the clutch.

In an example, the hand push working machine further includes a power motor and a work attachment, where the power motor is mounted to the body, the work attachment is driven by the power motor to perform a tool function, and the work attachment is an auger or a mowing blade.

A hand push working machine includes: a body; a walking wheel group used for supporting the body and including at least wheels; a self-moving motor including at least a motor shaft and configured to drive the wheels to rotate; and a transmission mechanism disposed between the self-moving motor and the walking wheel group and used for implementing the transmission between the self-moving motor and the wheels. The transmission mechanism includes a first clutch, a second clutch, and a drive apparatus, where the drive apparatus is connected to the second clutch and is at least used for driving the second clutch to switch between a locked state and an unlocked state. When the first clutch is in an unlocked state or the second clutch is in the unlocked state, the wheels are capable of rotating freely relative to the motor shaft.

In an example, the hand push working machine further includes a first operation member having a first position and a second position, where the second clutch enters the locked state when the first operation member is at the first position, and the second clutch enters the unlocked state when the first operation member is at the second position.

In an example, after the self-moving motor stops the drive, the first clutch enters the unlocked state when the wheels rotate by a certain angle in any direction.

In an example, the transmission mechanism further includes a first transmission gear, and the second clutch includes a first gear and a second gear, where the self-moving motor drives the first transmission gear to rotate, the first transmission gear drives the first gear to rotate, the first gear drives the second gear to rotate, and the second gear drives the wheels to rotate.

A snow blower includes: an operation member capable of being operated by a user; a snow throwing member; a first motor configured to drive the snow throwing member to rotate about a first axis; a first sensing apparatus configured to detect a first angle of the operation member and a second angle of the snow throwing member; and a first controller electrically connected to the first motor and the first sensing apparatus, configured to control the first motor to run, and further configured to acquire a first trigger signal outputted by the operation member. The first controller is configured to: when the second angle does not correspond to the first angle and the first trigger signal is received, control the first motor to run so that the second angle corresponds to the first angle.

In an example, the first sensing apparatus includes a first sensor and a second sensor, where the first sensor is configured to detect the first angle of the operation member in a left and right direction and the second sensor is configured to detect the second angle of the snow throwing member in the left and right direction.

In an example, when the operation member rotates leftward or rightward by a first preset angle, the first controller is configured to acquire, through the first sensor, the first trigger signal outputted by the operation member.

In an example, the first controller is further configured to: after the first motor is started, acquire the first angle of the operation member and the second angle of the snow throwing member in real time, set a second preset angle based on the acquired first angle, and turn off the first motor when the second angle is the same as the second preset angle.

In an example, the snow blower further includes a deflector and a second motor, where the deflector is connected to the snow throwing member and disposed on the snow throwing member, the second motor is configured to drive the deflector to rotate relative to the snow throwing member about a second axis, and the snow blower further includes a second sensing apparatus and a second controller electrically connected to the second sensing apparatus.

In an example, the second sensing apparatus includes a third sensor and a fourth sensor, where the third sensor is configured to sense a third angle of the operation member in an up and down direction and the fourth sensor is configured to sense a fourth angle of the deflector in the up and down direction.

In an example, when the operation member rotates upward or downward by a second preset angle, the second controller is configured to acquire, through the third sensor, a second trigger signal outputted by the operation member.

In an example, the second controller is configured to: when the third angle does not correspond to the fourth angle and the second trigger signal is received, control the second motor to run so that the fourth angle corresponds to the third angle.

In an example, a snow blower includes: an operation member capable of being operated by a user; a snow throwing member; a first motor configured to drive the snow throwing member to rotate about a first axis; a control unit including at least a first controller, where the first controller is electrically connected to the first motor and is configured to control the first motor to run; and a first sensing apparatus electrically connected to the first controller and configured to detect a first angle of the operation member and a second angle of the snow throwing member. The snow blower further includes a trigger apparatus electrically connected to the control unit and configured to output a trigger signal. The control unit is configured to: when the second angle does not correspond to the first angle and the trigger signal is received, control the first motor to run so that the second angle corresponds to the first angle.

In an example, the control unit further includes a third controller, where the trigger apparatus is electrically connected to the third controller, and the third controller is electrically connected to the first controller.

In an example, the third controller is connected to the trigger apparatus and configured to acquire the trigger signal outputted by the trigger apparatus.

In an example, the first controller is configured to: when the second angle does not correspond to the first angle and the trigger signal is received by the third controller, control the first motor to run so that the second angle corresponds to the first angle.

In an example, the first controller is connected to the trigger apparatus and configured to acquire the trigger signal outputted by the trigger apparatus.

In an example, the trigger apparatus is disposed on or near the operation member.

In an example, a snow blower includes: a body; and an operation assembly connected to the body and configured to allow an operator to guide and control the snow blower. The body includes: a snow throwing member; a deflector connected to the snow throwing member and disposed on the snow throwing member; and a motor configured to drive the deflector to rotate relative to the snow throwing member about a second axis. The body further includes a motor housing, where the motor is disposed in the motor housing and the motor housing includes a first portion and a second portion, where the first portion is fixedly mounted to the deflector and is rotatable relative to the second portion about the second axis.

In an example, the motor is in a second circular region which uses the second axis as a center, where the radius of the second circular region is greater than or equal to 25 mm and less than or equal to 75 mm.

In an example, the second portion of the motor housing is formed with a connection portion, where the first portion is slidably connected to the connection portion when the first portion rotates relative to the second portion about the second axis.

In an example, the motor housing further includes a third portion, and the second portion is rotatable relative to the third portion about a first axis, where the first axis is perpendicular to the second axis.

In an example, the body further includes a snow removal housing and a support rod extending along an up and down direction, where one end of the support rod is connected to the snow removal housing and the other end of the support rod is used for supporting the third portion of the motor housing.

In an example, the body further includes a circuit board assembly disposed in the third portion of the motor housing.

In an example, the body further includes a first motor configured to drive the snow throwing member to rotate relative to the body about the first axis.

In an example, the distance from the center of gravity of the first motor to the first axis is greater than or equal to 40 mm and less than or equal to 100 mm.

In an example, the first motor is disposed in the third portion of the motor housing; and the first motor is disposed under the circuit board assembly in the up and down direction.

In an example, the body further includes a first transmission mechanism connected to the first motor and a second transmission mechanism connected to the motor, where the first transmission mechanism and the second transmission mechanism are disposed in the motor housing.

### BRIEF DESCRIPTION OF THE DRAWINGS

FIG. 1 is a perspective view of a hand push working machine in an example of the present application;

FIG. 2 is a schematic view of a walking system of the hand push working machine in FIG. 1;

FIG. 3 is a sectional view of part of a transmission mechanism and a first clutch of the walking system in FIG. 2;

FIG. 4 is an exploded view of structures in FIG. 3;

FIG. 5a is a schematic view of movable members in the first clutch in FIG. 3 which are at locked positions;

FIG. 5b is a schematic view of movable members in the first clutch in FIG. 3 which are at unlocked positions;

FIG. 6 is a schematic view of part of a transmission mechanism and a second clutch of the walking system in FIG. 2;

FIG. 7 is a schematic view of the second clutch in FIG. 6 from another perspective;

FIG. 8 is a schematic view of the second clutch in FIG. 6 from another perspective;

FIG. 9a is a sectional view showing a first state of the second clutch in FIG. 6;

FIG. 9b is a sectional view showing a second state of the second clutch in FIG. 6;

FIG. 10 is a schematic view showing multiple turning radii of a hand push working machine in the present application;

FIG. 11 is a schematic view showing another connection manner between a second clutch and a drive member;

FIG. 12 is a sectional view of a structure in FIG. 11;

FIG. 13 is an exploded view of a structure in FIG. 11;

FIG. 14 is a schematic view of a partial structure of a snow removal system of the hand push working machine in FIG. 1;

FIG. 15 is an exploded view of the partial structure of the snow removal system in FIG. 14;

FIG. 16 is a schematic view of a power motor, an impeller, and an auger in a snow removal system;

FIG. 17 is a structural view of a snow throwing system of the hand push working machine in FIG. 1;

FIG. 18 is a structural view of the snow throwing system in FIG. 17 with a motor housing removed;

FIG. 19 is a schematic view of a first transmission mechanism of a first drive apparatus in FIG. 18;

FIG. 20 is an exploded view of a partial structure of the snow throwing system in FIG. 17;

FIG. 21 is a structural view showing another state of a motor housing of a snow throwing system;

FIG. 22 is a schematic view showing the positions of a first motor and a second motor in a snow throwing system relative to the snow throwing system;

FIG. 23 is a schematic view showing the positions of a first motor and a second motor in another example relative to a snow throwing system;

FIG. 24 is a control principle diagram of a control apparatus of the snow throwing system in FIG. 20;

FIG. 25 is a flowchart of a method for controlling a snow throwing member in a snow throwing system; and

FIG. 26 is a flowchart of a method for controlling a deflector in a snow throwing system.

### DETAILED DESCRIPTION

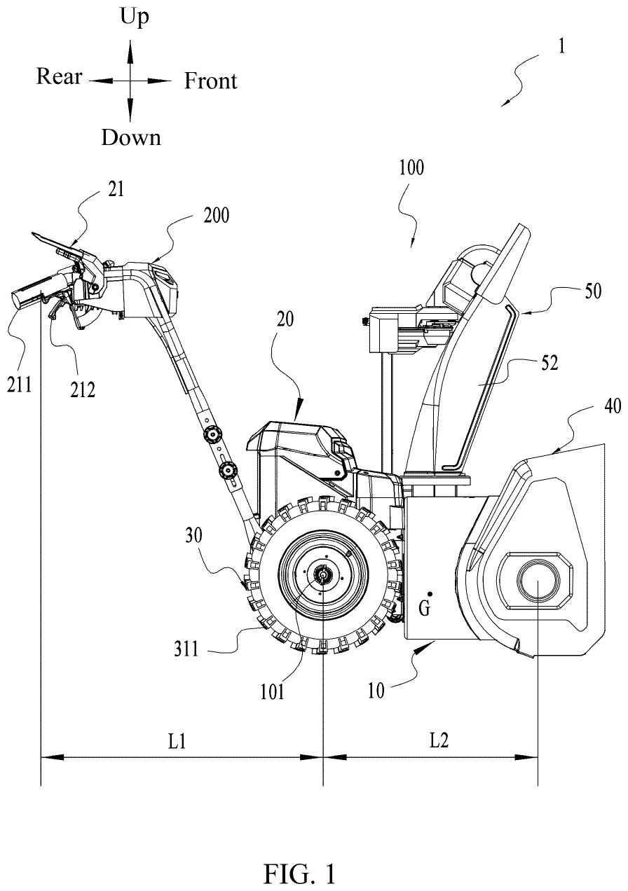

FIG. 1 shows a schematic view of a hand push working machine 1 in an example. The hand push working machine 1 includes a body 100 and an operation assembly 200 connected to the body 100. The operation assembly 200 includes an upper connection rod, and the body 100 includes a lower connection rod. The upper connection rod and the lower connection rod are connected to each other by fasteners such as screws and nuts so that the body 100 is connected to the operation assembly 200. The upper connection rod and the lower connection rod constitute a telescopic connection so that the height of the operation assembly 200 relative to the ground is adjusted. The operation assembly 200 further includes a handle assembly 21 for a user to operate. The user may push the handle assembly 21 to move the body 100 relative to the ground, thereby causing the hand push working machine 1 to move relative to the ground. The body 100 includes a body housing 10, an energy system, a walking system 30, a snow removal system 40, and a snow throwing system 50. The energy system includes a battery pack 20. The battery pack 20 may be a single battery pack or may include multiple battery packs. The energy system in this example includes dual DC lithium battery packs. For the convenience of description, according to the travelling direction of the hand push working machine 1 under general working conditions, the front, rear, up, and down directions are defined as shown in FIG. 1.

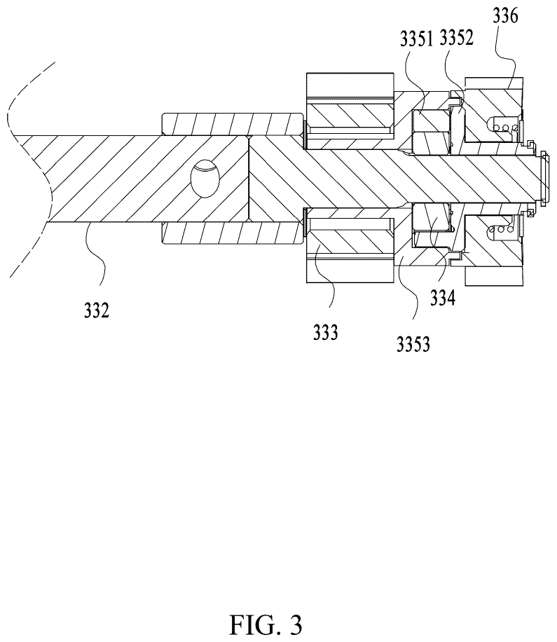

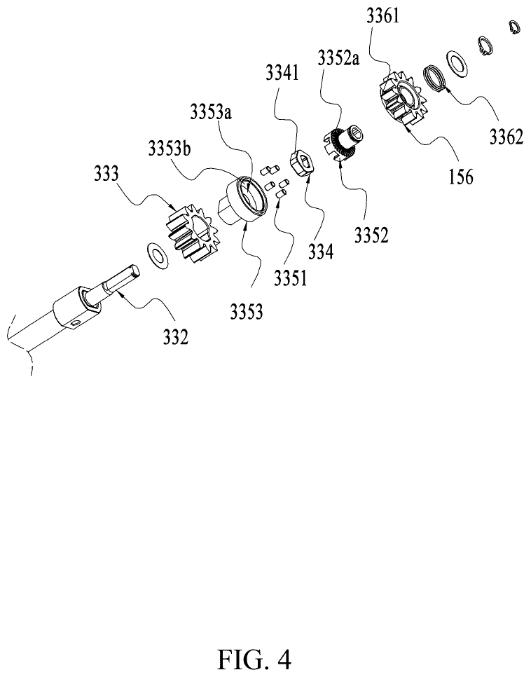

Referring to FIG. 1 to FIG. 4, the walking system 30 includes a walking wheel group, a self-moving motor 32, and a transmission mechanism 33. The walking wheel group includes wheels 311 which can walk on the ground. The wheels 311 rotate relative to the body 100 about a first straight line 101 so that the hand push working machine 1 moves relative to the ground. Optionally, the wheels 311 include a first wheel and a second wheel which are symmetrically distributed on two sides of the body 100, where the first wheel and the second wheel are connected to each other by a walking wheel shaft 312.

The self-moving motor 32 is configured to drive the wheels 311 to rotate relative to the body 100 about the first straight line 101 so that the hand push working machine 1 moves relative to the ground. The self-moving motor 32 includes a motor shaft, and the motor shaft drives the wheels 311 to rotate. In this example, the self-moving motor 32 is an electric motor, and the motor shaft is the shaft of the electric motor. The self-moving motor 32 may also be referred to as a self-moving electric motor. In an optional example, the self-moving motor may be an internal combustion engine powered by fuel combustion.

The transmission mechanism 33 is used for transmitting power between the self-moving motor 32 and the walking wheel group so that the motor shaft can drive the wheels 311 to rotate when actively rotating. The transmission mechanism 33 includes a gearbox 331 and a transmission shaft 332 connected to the gearbox 331. The gearbox 331 is connected to the motor shaft of the self-moving motor 32 and used for transmitting the power of the self-moving motor 32 to the transmission shaft 332.

The transmission mechanism 33 further includes a first transmission gear 333 and a fixed member 334. The fixed member 334 is connected to the transmission shaft 332 and rotates synchronously with the transmission shaft 332. The first transmission gear 333 also meshes with a first gear 3371. Optionally, when the self-moving motor 32 is in a working state or the motor shaft actively rotates, the motor shaft drives the transmission shaft 332 to rotate, the transmission shaft 332 drives the fixed member 334 to rotate, the fixed member 334 drives the first transmission gear 333 to rotate, and the first transmission gear 333 drives the wheels 311 to rotate. A structure and a working principle for the first transmission gear 333 to drive the wheels 311 to rotate are described in detail below.

The transmission mechanism 33 further includes a first clutch 335 and a second transmission gear 336. Two first clutches 335 are provided, and each of the first wheel and the second wheel is connected to a respective one of the two first clutches 335 separately. Optionally, the first clutch 335 includes movable members 3351, a drive paddle 3352, and an outer ring member 3353. When the wheels 311 rotate, because the second transmission gear 336 meshes with a first wheel gear 3111 of a wheel 311, the first wheel gear 3111 can drive the second transmission gear 336 to rotate. Because the rotation direction of the first transmission gear 333 is opposite to the rotation direction of the second transmission gear 336, the second transmission gear 336 applies an action force opposite to the rotation direction of the first transmission gear 333 to the drive paddle 3352. Optionally, the second transmission gear 336 includes a first connection portion 3361, and the drive paddle 3352 includes a second connection portion 3352a. The first connection portion 3361 can mesh with the second connection portion 3352a so that the second transmission gear 336 and the drive paddle 3352 rotate in the same direction.

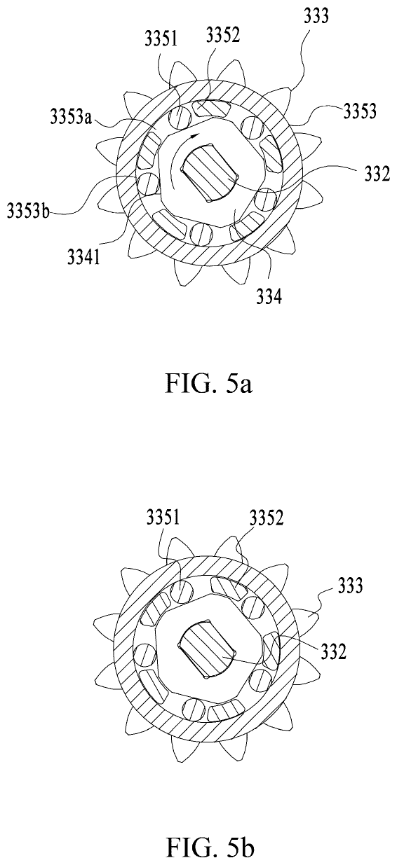

The drive paddle 3352 is driven by the wheel 311 and used for causing the movable members 3351 to move relative to the transmission shaft 332 between locked positions and unlocked positions. The outer ring member 3353 is sleeved on the periphery of the transmission shaft 332. The outer ring member 3353 is formed with a mounting slot 3353a. The mounting slot 3353a accommodates the fixed member 334 and the movable members 3351. The fixed member 334 is formed with drive surfaces 3341. Optionally, a movable member 3351 is a pin. Multiple pins are disposed in the mounting slot 3353a. The number of drive surfaces 3341 is the same as the number of pins. A pin is located between the slot wall 3353b of the mounting slot 3353a and a respective drive surface 3341. Optionally, multiple drive surfaces and multiple pins may be provided so that torque which can be transmitted between the drive surfaces and the pins may be improved. For example, six drive surfaces and six pins are provided. FIGS. 5a and 5b illustrate the state in which the movable members 3351 are at the locked positions and the state in which the movable members 3351 are at the unlocked positions, respectively. When the movable members 3351 are at the locked positions, the transmission shaft 332 can drive the wheels 311 to rotate. When the movable members 3351 are at the unlocked positions, the wheels 311 can rotate freely relative to the transmission shaft 332. That is, when the wheels 311 rotate clockwise or counterclockwise, the wheels 311 do not drive the transmission shaft 332 to rotate.

The transmission mechanism 33 further includes a first elastic element 3362. The first elastic element 3362 is used for applying an action force on the second transmission gear 336 so that the first connection portion 3361 of the second transmission gear 336 meshes with the second connection portion 3352a of the drive paddle 3352 tightly. Thus, the transmission between the second transmission gear 336 and the drive paddle 3352 is implemented, and the reliability of the transmission mechanism 33 is improved so that the performance of the transmission between the second transmission gear 336 and the drive paddle 3352 is more stable.

When the self-moving motor 32 is in the working state, that is, the motor shaft drives the transmission shaft 332 to rotate, the transmission shaft 332 drives the fixed member 334 to rotate along the direction (a clockwise direction) shown by the arrow in FIG. 5a. The movable members 3351 are in contact with the slot wall 3353b of the mounting slot 3353a and the drive surfaces 3341 at the same time so that the transmission shaft 332 drives the outer ring member 3353 to rotate along the clockwise direction. The first transmission gear 333 is sleeved on the outer side of the outer ring member 3353. The transmission between the first transmission gear 333 and the outer ring member 3353 is implemented through a flat portion. The outer ring member 3353 rotates along the clockwise direction to drive the first transmission gear 333 to rotate along the clockwise direction. The first transmission gear 333 drives the wheels 311 to rotate. When the wheels 311 are driven to rotate by the self-moving motor 32, the drive paddle 3352 is subjected to the action force of the wheels 311 which is opposite to the rotation direction of the first transmission gear 333, that is, the drive paddle 3352 is subjected to the action force along a counterclockwise direction. The drive paddle 3352 is driven by the wheels 311 to rotate to the position shown in FIG. 5a. In this case, the drive paddle 3352 blocks the movements of the movable members 3351, resulting in that the movable members 3351 cannot move from the locked positions to the unlocked positions, or in other words, the movable members 3351 are kept at the locked positions.

After the self-moving motor 32 stops the drive, when the user pushes forward the hand push working machine 1, the wheels 311 actively rotate. In this case, the wheels 311 drive, through the first wheel gear 3311, the second transmission gear 336 to rotate along the clockwise direction. The second transmission gear 336 drives the outer ring member 3353 to rotate along the clockwise direction. The outer ring member 3353 rotates along the clockwise direction relative to the transmission shaft 332 to disengage the movable members 3351 from the locked positions, as shown in FIG. 5b. In this case, the movable members 3351 cannot be in contact with the slot wall 3353b of the mounting slot 3353a and the drive surfaces 3341 of the fixed member 334 at the same time. In this case, the outer ring member 3353 can rotate relative to the transmission shaft 332. That is, the wheels 311 can rotate relative to the transmission shaft 332. Optionally, when the user pushes the hand push working machine 1 to rotate the wheels 311 by a certain angle in any direction while the self-moving motor 32 is in the off state, the first clutch 335 enters an unlocked state, which may be understood as follows: the user may push the hand push working machine 1 forward or backward to cause the wheels 311 to rotate clockwise or counterclockwise so that the first clutch 335 may enter the unlocked state. The self-moving motor 32 is in the off state, which means that the self-moving motor 32 does not drive the wheels 311 to rotate.

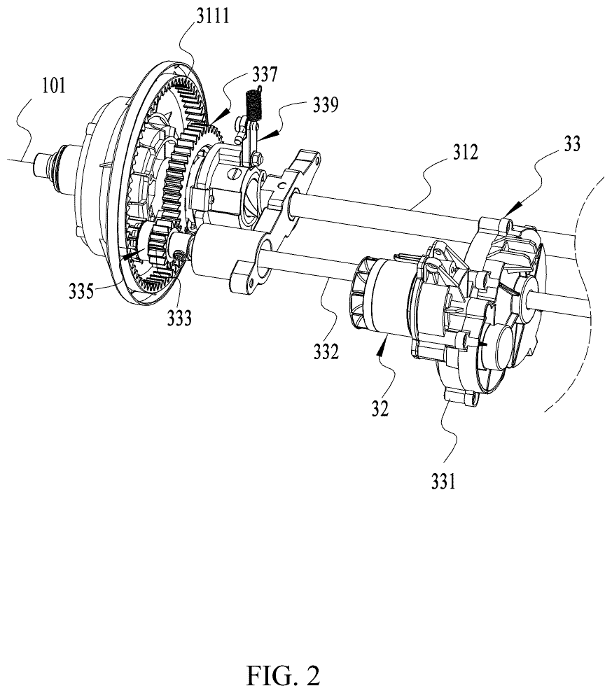

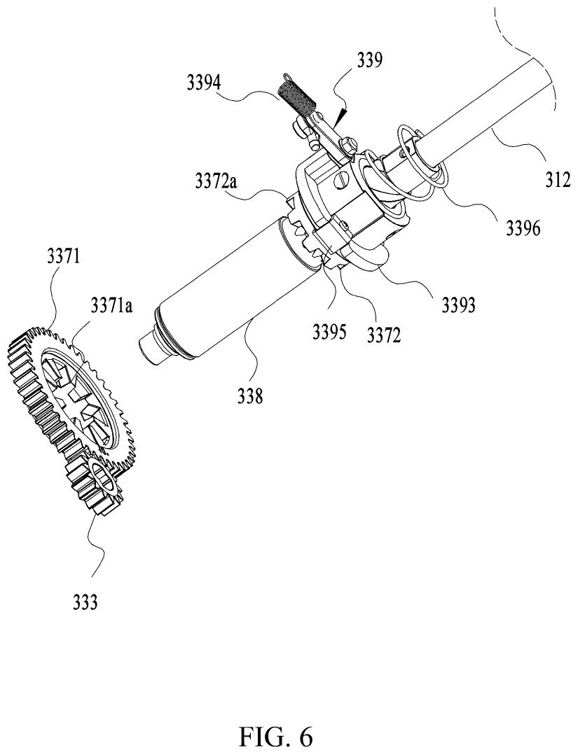

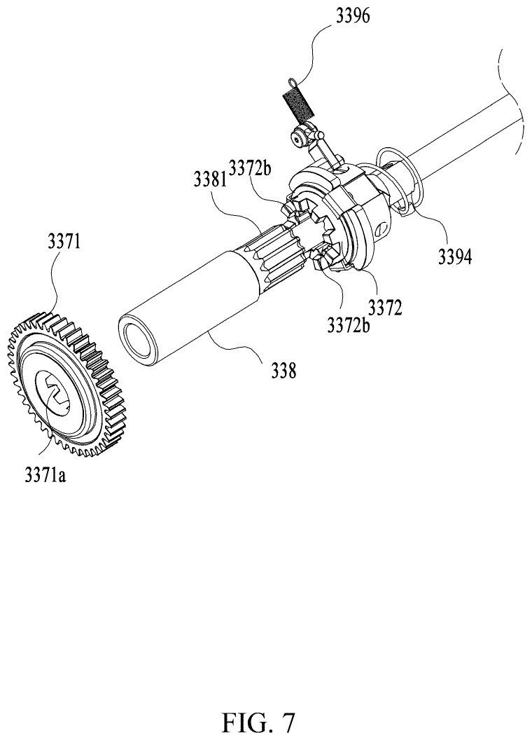

Referring to FIG. 2 and FIG. 6 to FIG. 8, the transmission mechanism 33 further includes a second clutch 337, an output shaft 338, and a drive apparatus 339. Two second clutches 337 are provided, and each of the first wheel and the second wheel are connected to a respective one of the two second clutches 337 separately. The second clutch 337 is driven by the first transmission gear 333 and used for transmitting the power which is transmitted by the motor shaft to the first transmission gear 333 to the output shaft 338, so as to drive the output shaft 338 to rotate about the first straight line 101. The output shaft 338 is connected to the wheels 311 and used for driving the wheels 311 to rotate about the first straight line 101. The second clutch 337 has a first state and a second state. When the second clutch 337 is in the first state, the power transmitted by the motor shaft to the second transmission gear 333 can be transmitted to the output shaft 338 by the second clutch 337. When the second clutch 337 is in the second state, the power transmitted by the motor shaft to the second transmission gear 333 cannot be transmitted to the output shaft 338, which may be understood as follows: when the second clutch 337 is in the second state, the motor shaft rotates normally, but the second clutch 337 is separated from the output shaft 338 and the wheels 311 can rotate freely relative to the motor shaft. The drive apparatus 339 is used for driving the second clutch 337 to switch between the first state and the second state.

The second clutch 337 includes a first gear 3371 and a second gear 3372. The first gear 3371 is driven by the first transmission gear 333, and the second gear 3372 is driven by the first gear 3371. Optionally, the first gear 3371 has first internal teeth 3371a, and the second gear 3372 has first external teeth 3372a, where the first internal teeth 3371a mesh with the first external teeth 3372a so that power on the first gear 3371 is transmitted to the second gear 3372.

When the second clutch 337 is in the first state, the first internal teeth 3371a mesh with the first external teeth 3372a. When the second clutch 337 is in the second state, the first external teeth 3372a are separated from the first internal teeth 3371a.

The output shaft 338 is sleeved on the walking wheel shaft 312 and used for driving the wheels 311 to rotate about the first straight line 101. Optionally, the output shaft 338 is formed with second external teeth 3381, and the second gear 3372 is formed with second internal teeth 3372b, where the second external teeth 3381 mesh with the second internal teeth 3372b so that power on the second gear 3372 is transmitted to the output shaft 338 to drive the wheels 311 to rotate.

The drive apparatus 339 is connected to the second clutch 337 and used for driving the second clutch 337 to switch between the first state and the second state. The handle assembly 21 includes a first operation member 212 controlled by the user, and the drive apparatus 339 is controlled by the first operation member 212. Optionally, when the first operation member 212 is at the first position, the drive apparatus 339 drives the second clutch 337 to be in the first state. In this example, as shown in FIG. 1, the first operation member 212 is configured to be a trigger for the user to operate. When the user controls the first operation member 212 to be at the second position, the drive apparatus 339 drives the second clutch 337 to switch from the first state to the second state. When the user controls the first operation member 212 to switch from the first position to the second position, the drive apparatus 339 rotates about the first straight line 101. Thus, the second gear 3372 of the second clutch 337 is driven to move along the direction of the first straight line 101 so that the first external teeth 3372a are separated from the first internal teeth 3371 and the second clutch 337 switches from the first state to the second state.

Optionally, the drive apparatus 339 includes a spiral shaft sleeve 3391, a drive member 3393, and steel balls 3392 disposed between the spiral shaft sleeve 3391 and the drive member 3393. The spiral shaft sleeve 3391 is sleeved on the walking wheel shaft 312 and is fixedly connected to the walking wheel shaft 312. Optionally, a through hole 3391b is formed between the spiral shaft sleeve 3391 and the walking wheel shaft 312, and a fastener 3391c passes through the through hole 3391b to fix the spiral shaft sleeve 3391 to the walking wheel shaft 312. Spiral grooves 3391a are formed on the spiral shaft sleeve 3391, and the steel balls 3392 are disposed in the spiral grooves 3391a. The drive member 3393 is formed with positioning holes 3393a, and the steel balls 3392 are at least partially disposed in the positioning holes 3393a. The drive member 3393 further includes limiting members 3393b, and the limiting members 3393b are at least partially disposed in the positioning holes 3393a and are used for limiting the steel balls 3392. A connection rod 3393c is further formed on or connected to the drive member 3393. A second elastic member 3394 is connected to or formed on the connection rod 3393c. The second elastic member 3394 is fixedly connected to the body 100.

The drive apparatus 339 is connected to the second clutch 337 by a connector 3395. The connector 3395 is fixedly connected to the drive member 3393 and is used for driving the second gear 3372 and the drive member 3393 to move synchronously in the direction of the first straight line 101. Optionally, the connector 3395 is configured to be a U-shaped clip. One end of the U-shaped clip is fixed to the drive member 3393, and the other end of the U-shaped clip forms a clearance fit with a first end surface 3372c of the second gear 3372. When the second gear 3372 of the second clutch 337 is driven to rotate about the first straight line 101 by the first gear 3371, the power of the second gear 3372 is not transmitted to the drive member 3393 because the U-shaped clip forms the clearance fit with the first end surface 3372c of the second gear 3372, which may be understood as follows: the movement of the second gear 3372 and the movement of the drive member 3393 on a plane perpendicular to the first straight line 101 are not related to each other.

In a normal walking process of the hand push working machine 1, the movable members 3351 are at the locked positions, the first operation member 212 is at a first position, the second clutch 337 is in the first state, the motor shaft drives the transmission shaft 332 to rotate, the transmission shaft 332 drives the first transmission gear 333 to rotate, the first transmission gear 333 drives the first gear 3371 to rotate, the first gear 3371 drives the second gear 3372 to rotate, and the second gear 3372 drives the output shaft 338 to rotate, so as to drive the wheels 331 to rotate.

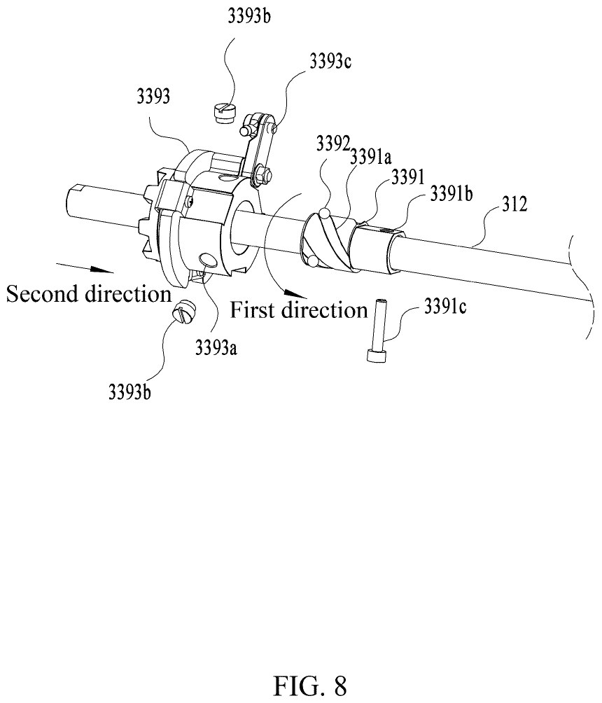

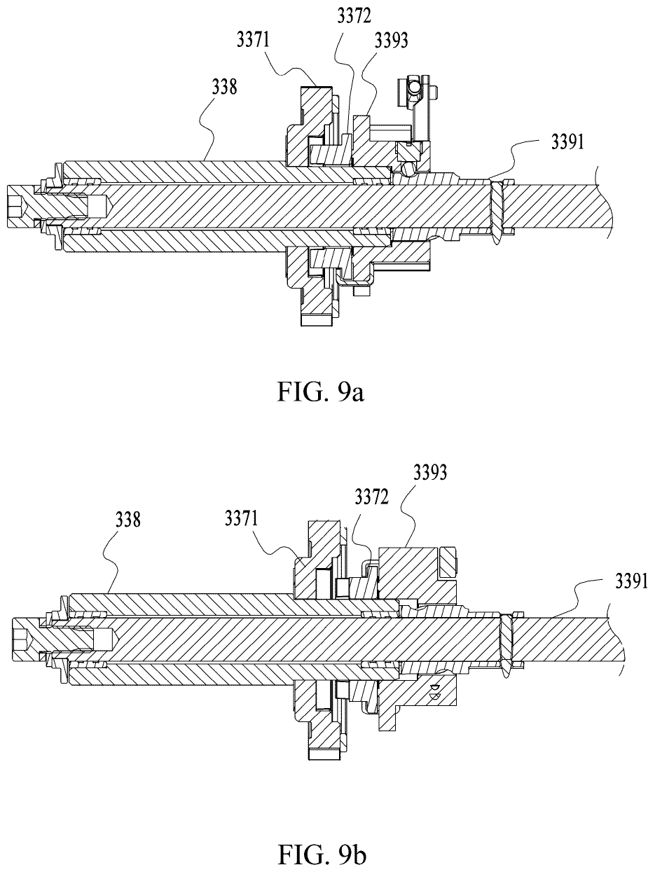

When the user needs to perform steering in the walking process, the first operation member 212 may be controlled to switch from the first position to the second position. In the process in which the first operation member 212 switches from the first position to the second position, the second clutch 337 switches from the first state to the second state. When the second clutch 337 is in the first state, the positional relationship between the first gear 3371 and the second gear 3372 is shown in FIG. 9a, and when the second clutch 337 is in the second state, the positional relationship between the first gear 3371 and the second gear 3372 is shown in FIG. 9b. Optionally, in the process in which an operation member 22 switches from the first position to the second position, the drive member 3393 moves, under the action of the connection rod 3393c, along a first direction shown in FIG. 8. The steel balls 3392 can only move in the spiral grooves 3391a of the spiral shaft sleeve 3391. Therefore, at the same time, the drive member 3393 moves, under the action of the steel balls 3392, along a second direction shown in FIG. 8. When moving along the second direction, the drive member 3393 drives the second gear 3372 to move along the second direction so that the first external teeth 3372a of the second gear 3372 are gradually separated from the first internal teeth 3371a of the first gear 3371, thereby causing the second clutch 337 to be in the second state.

In this example, each of the first clutch 335 and the second clutch 337 has a driving state and an unlocked state. The driving state of the second clutch 337 is the first state of the second clutch 337, and the unlocked state of the second clutch 337 is the second state of the second clutch 337. When the first clutch 335 and the second clutch 337 are each in the driving state, the motor shaft drives the wheels 13 to rotate, and the hand push working machine 1 works normally. When the first clutch 335 or the second clutch 337 is in the unlocked state, the wheels 13 can rotate freely relative to the motor shaft, that is, the user may push the hand push working machine 1 to steer.

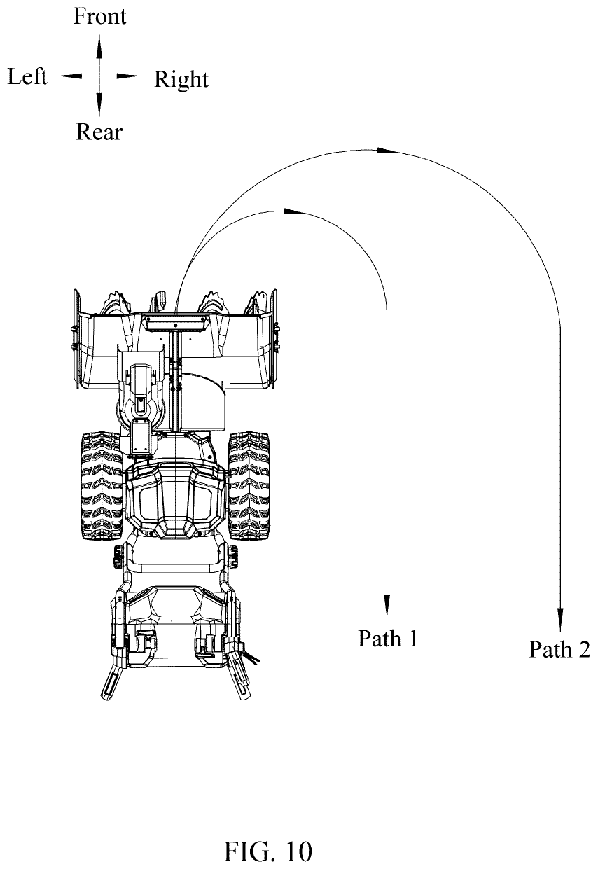

Referring to FIG. 10, when the hand push working machine 1 is in a self-moving state and an angle by which the user needs to steer is relatively small, the first clutch 335 may be configured to be in the unlocked state, the second clutch 337 may be configured to be in the driving state, and the hand push working machine 1 turns along the direction shown in a path 2 in FIG. 10. In this case, a turning radius is relatively large. Optionally, in this case, without operating the first operation member 212, the user may directly push the hand push working machine 1 to turn. The principle of this turning operation is briefly described below. When the user does not operate the first operation member 212 and the hand push working machine 1 needs to turn, the user may directly apply a steering force to the hand push working machine 1 to turn the hand push working machine 1. The steering force causes the first wheel and/or the second wheel to move relative to the self-moving motor 32. The relative movement causes at least one of the two first clutches 335 to switch to the unlocked state. In this way, a speed difference is generated between the first wheel and the second wheel so that the hand push working machine 1 may turn. It is to be noted that since the two first clutches 335 are in the unlocked state which is not very stable and may change between the unlocked state and the driving state in this case and the hand push working machine 1 is still in the state in which the self-moving motor 32 outputs a driving force, the speed difference between the first wheel and the second wheel is relatively small. Therefore, the turning radius of the hand push working machine 1 is relatively large in this case.

When the angle by which the user needs to steer is relatively small, the second clutch 337 may be configured to be in the unlocked state. The hand push working machine 1 turns along the direction shown in a path 1 in FIG. 10. In this case, a turning radius is relatively small, and the working efficiency of the hand push working machine 1 can be effectively improved. Optionally, in this case, the user may switch the second clutch 337 to the unlocked state by operating the first operation member 212 and push the hand push working machine 1 to turn. The principle of this turning operation is briefly described below. When the user needs to perform a small-radius turn, for example, a turn to the right, the user operates the first operation member 212 on the right-hand side so that the second clutch 337 connected to a right wheel is in the unlocked state. Then, the right wheel is not driven by the self-moving motor 32 and a left wheel is driven by the self-moving motor 32 so that a relatively large speed difference is generated between the first wheel and the second wheel. Thus, a relatively small turning radius and a relatively large turning angle can be implemented.

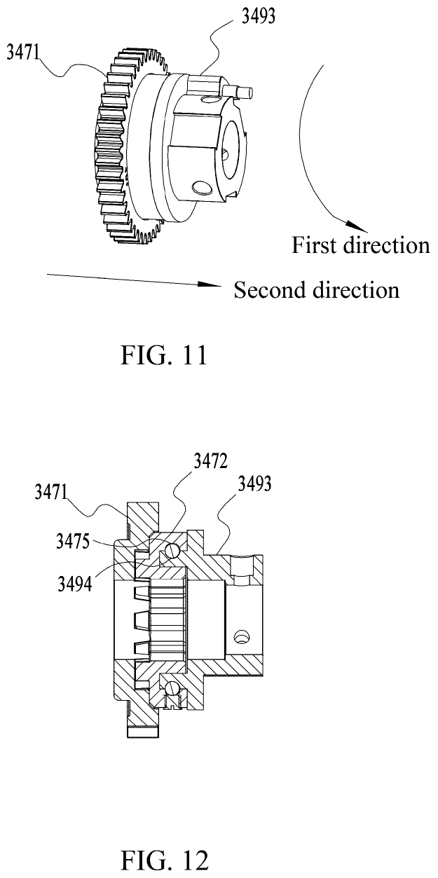

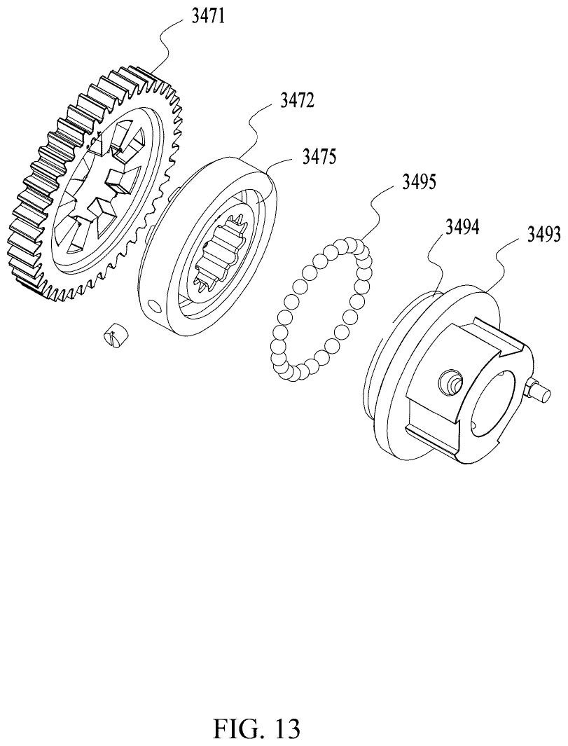

In other examples, the connector connecting the drive apparatus to the second clutch may be implemented with another form of structure. Optionally, the connector is disposed between the clutch and the drive apparatus. Referring to FIG. 11 to FIG. 13, a connector 3495 is disposed between a second gear 3472 and a drive member 3493 and used for implementing the synchronous movement between the second gear 3472 and the drive member 3493 in a second direction. Optionally, the connector 3495 is configured to be multiple balls. The second gear 3472 is formed with a first annular groove 3475, the drive member 3493 is formed with a second annular groove 3494 disposed opposite to the first annular groove 3475, and the first annular groove 3475 and the second annular groove 3494 form an accommodating space. The multiple balls can roll in the preceding accommodating space along the first annular groove 3475 or the second annular groove 3494. When the first operation member 212 controls the drive member 3493 to rotate along the first direction, the second gear 3472 is driven by the connector 3495 to move along the second direction so that the clutch switches from the first state to the second state.

In some examples, the hand push working machine 1 has a manual push working state and a self-driving state. When the hand push working machine 1 is in the manual push working state, the user can manually push the hand push working machine 1 to travel forward or backward. When the hand push working machine 1 is in the self-driving state, the user does not need to manually push the hand push working machine, and the self-driving motor 14 can drive the hand push working machine 1 to travel. In an optional example, the hand push working machine 1 is provided with a toggle switch for the manual push working state and the self-driving state.

In some examples, the hand push working machine 1 has a self-driving forward mode and a self-driving backward mode. A rotational speed of wheels 131 in the self-driving forward mode is higher than a rotational speed of the wheels 131 in the self-driving backward mode. In an optional example, the hand push working machine 1 includes two start switches by which the self-driving forward mode and the self-driving backward mode are started separately. In another optional example, the hand push working machine 1 includes a toggle switch for switching between the self-driving forward mode and the self-driving backward mode. In another optional example, the user pushes the handle assembly 21 forward and the hand push working machine 1 enters the self-driving forward mode, and the user pushes the handle assembly 21 backward and the hand push working machine 1 enters the self-driving backward mode.

The hand push working machine 1 in the preceding example may be configured to be a snow blower. Of course, the hand push working machine 1 may be configured to be another hand push power tool, for example, a mower.

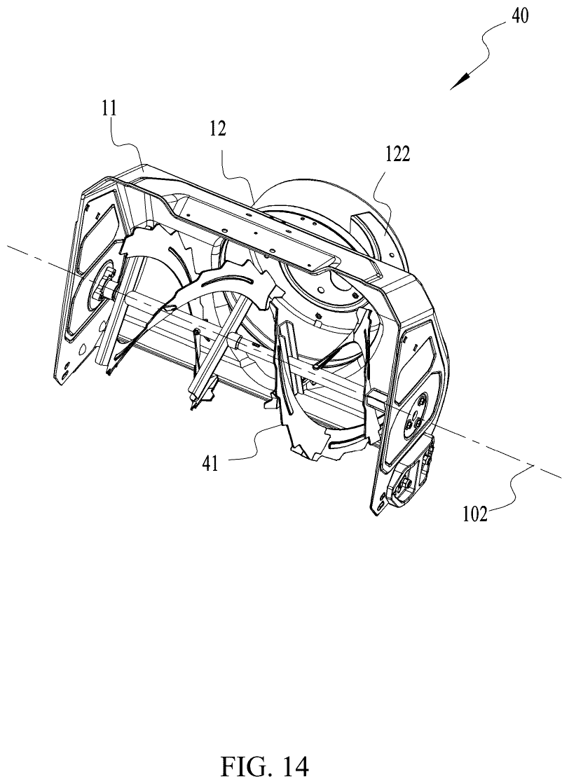

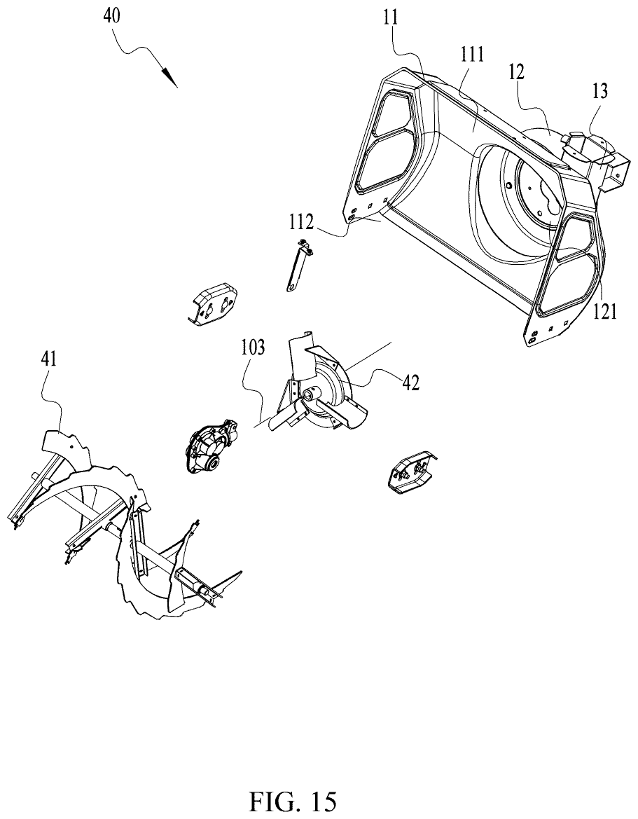

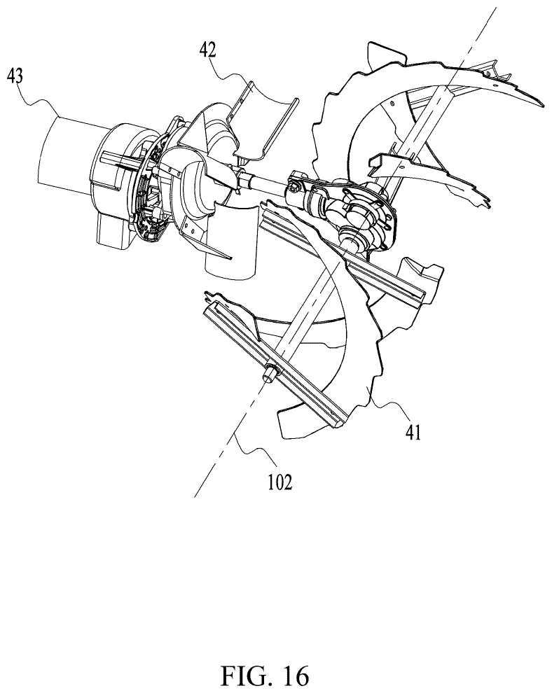

As shown in FIG. 1 and FIG. 14 to FIG. 16, the hand push working machine 1 is optionally configured to be a snow blower, and the snow removal system 40 of the snow blower includes an auger 41 and an impeller 42. The auger 41 is a functional element of the snow blower and is used for stirring snow on the ground. The body housing 10 includes an auger housing 11 and an impeller housing 12. The auger housing 11 is formed with a first accommodating space 111 which accommodates at least part of the auger 41. The auger 41 can rotate about a second straight line 102 in the first accommodating space 111. The impeller housing 12 is formed with a second accommodating space 121 which accommodates at least part of the impeller 42. The impeller 42 can rotate about a third straight line 103 in the impeller housing 12. The second straight line 102 is perpendicular to the third straight line 103. The first accommodating space 111 and the second accommodating space 121 communicate with each other. A snow inlet 112 is defined for the first accommodating space 111, and a snow outlet 122 is defined for the second accommodating space 121. Under the action of the auger 41, the snow enters the auger housing 11 from the snow inlet 112 of the auger housing 11 and is discharged from the snow outlet 122 after the further action of the impeller 42. Optionally, the first accommodating space 111 is larger than the second accommodating space 121, and the first accommodating space 111 is disposed on the front side of the second accommodating space 121 along the forward direction of the snow blower. The auger housing 11 and the impeller housing 12 are integrally formed or mechanically connected to each other to implement the communication between the first accommodating space 111 and the second accommodating space 121. The body housing 10 further includes a snow chimney 13 protruding from the second accommodating space 121, and the snow chimney 13 substantially extends along a tangential direction of the cylinder and is connected to the snow outlet 122. The space surrounded by the snow chimney 13 communicates with the second accommodating space 121. In this example, the auger housing 11, the impeller housing 12, and the snow chimney 13 are stamping parts which are connected as a whole by welding.

The snow removal system 40 further includes a power motor 43 configured to drive the auger 41 to rotate about the second straight line 102 and drive the impeller 42 to rotate about the third straight line 103. Optionally, output power of the power motor 43 is greater than or equal to 3000 W and less than or equal to 6000 W, and an output rotational speed of the power motor 43 is higher than or equal to 5000 rpm and lower than or equal to 15000 rpm. The rotational speed of the impeller 42 is higher than or equal to 500 rpm and lower than or equal to 1500 rpm, which ensures that the snow blower has better snow removal performance.

Referring to FIG. 1, the handle assembly 21 includes operation handles 211 for the user to operate, and the two operation handles 211 are separately disposed on the left and right sides of the snow blower shown in FIG. 10. It is defined that the center of gravity of the whole snow blower is G. The center of gravity G is approximately at the intermediate position of the snow blower along a front and rear direction, and the center of gravity G is between the first straight line 101 and the second straight line 102 in the front and rear direction. In the front and rear direction, the distance from the holding center of an operation handle 211 to the first straight line 101 is L1, the distance from the first straight line 101 to the second straight line 102 is L2, and the ratio of L1 to L2 is higher than or equal to 1 and lower than or equal to 1.6. The battery pack 20 is at least partially located above the walking wheel shaft 312 to balance the center of gravity G.

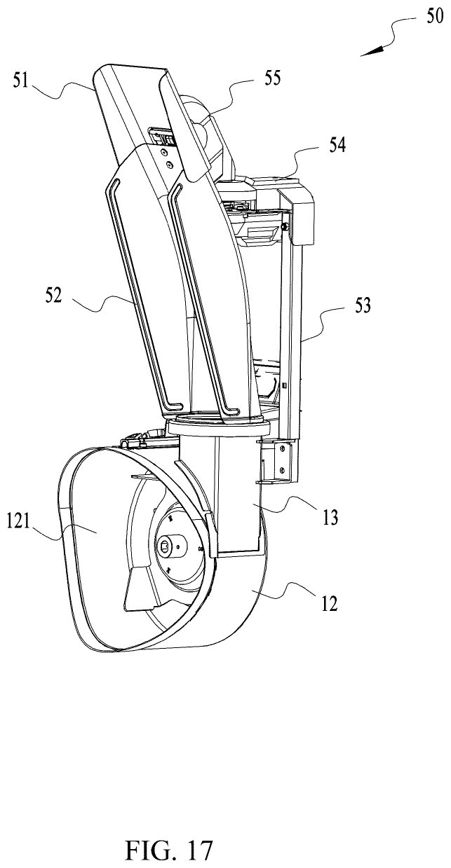

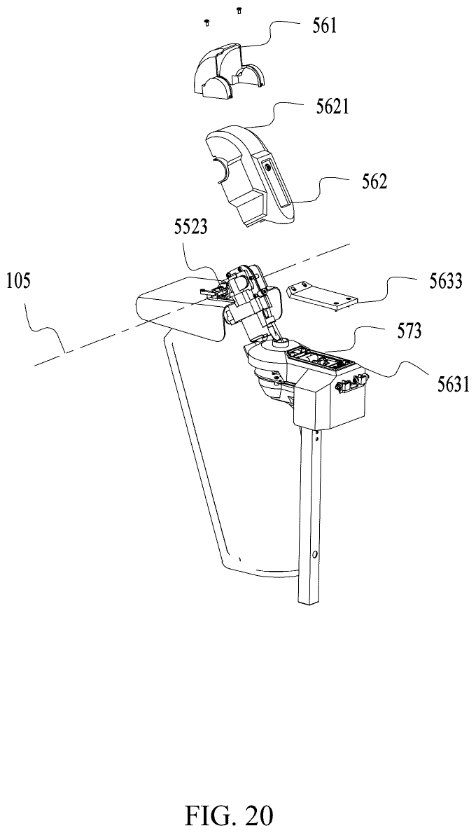

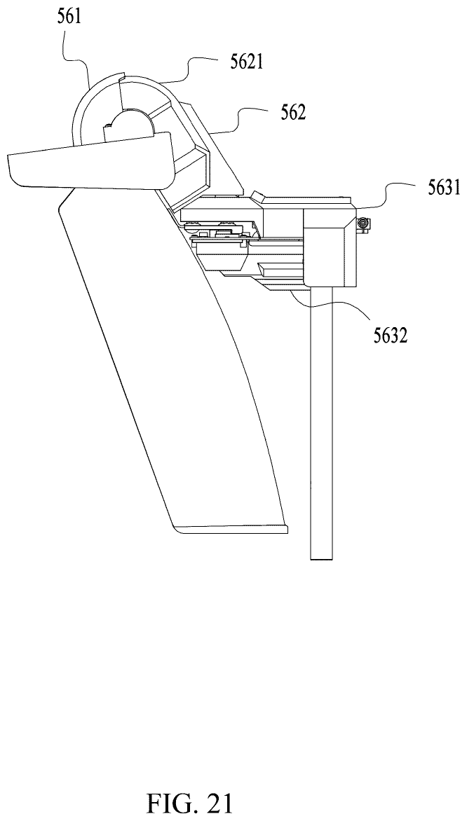

Referring to FIG. 1 and FIG. 17 to FIG. 22, the snow throwing system 50 of the snow blower includes a deflector 51 and a snow throwing member 52. The snow throwing member 52 surrounds a semi-closed channel and defines an opening. A first end of the snow throwing member 52 is rotatably connected to the impeller housing 12 to cause the second accommodating space 121 to communicate with the outside. That is to say, the snow throwing member 52 is connected to the impeller housing 12 and the deflector 51 so that a continuous channel for discharging the snow is formed. The deflector 51 is mounted to a second end of the snow throwing member 52. In this example, the deflector 51 is mounted to the top of the snow throwing member 52. After passing through the impeller housing 12, the snow chimney 13, the snow throwing member 52, and the deflector 51, the snow is thrown into the air.

The snow throwing system 50 further includes a first drive apparatus 54 and a second drive apparatus 55. The first drive apparatus 54 is connected to the upper or middle portion of the snow throwing member 52 and used for driving the snow throwing member 52 to rotate relative to the body 100 about a first axis 104. The second drive apparatus 55 is connected to the deflector 51 and used for driving the deflector 51 to rotate relative to the snow throwing member 52 about a second axis 105. The first axis 104 is perpendicular to the second axis 105.

Optionally, the first drive apparatus 54 includes at least a first motor 541 and a first transmission mechanism 542. The first transmission mechanism 542 includes at least a third gear 5421, a fourth gear 5422, and a first output shaft 5423. The first motor 541 drives the third gear 5421 to rotate, the third gear 5421 drives the fourth gear 5422 to rotate, and the fourth gear 5422 drives the first output shaft 5423 to rotate about the first axis 104. Optionally, the third gear 5421 and the fourth gear 5422 are configured to be bevel gears. The first drive apparatus 54 further includes a rotating member 543. One end of the rotating member 543 is sleeved on the first output shaft 5423 and rotates with the first output shaft 5423. The other end of the rotating member 543 is fixedly connected to the snow throwing member 52 and is used for driving the snow throwing member 52 to rotate about the first axis 104.

The second drive apparatus 55 includes a second motor 551 and a second transmission mechanism 552. The second transmission mechanism 552 includes at least a worm shaft 5521, a first worm gear 5522, and a second output shaft 5523. The second motor 551 drives the worm shaft 5521 to rotate, and the worm shaft 5521 drives the first worm gear 5522 to drive the second output shaft 5523 to rotate about the second axis 105. The second output shaft 5523 drives the deflector 51 to rotate about the second axis 105.

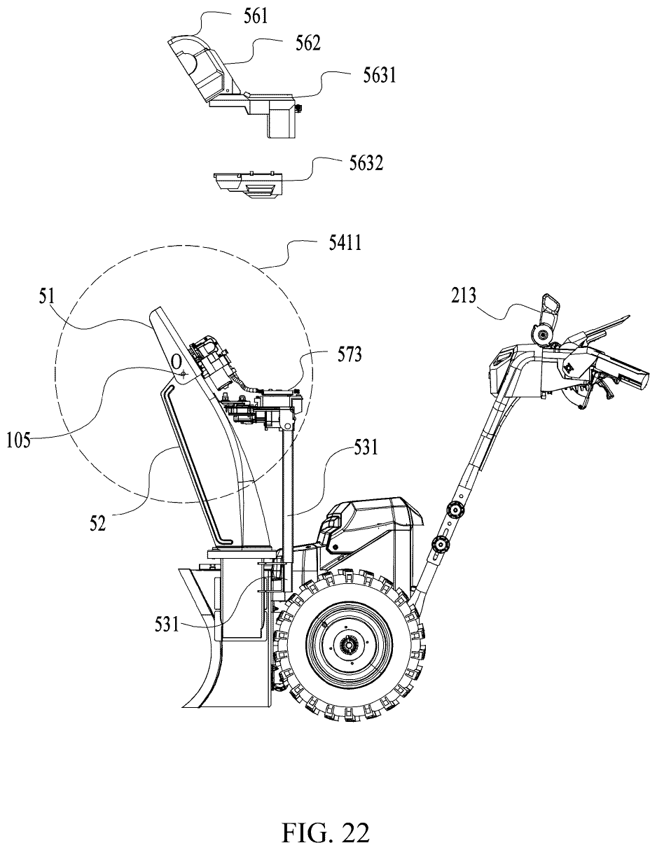

When the snow throwing member 52 is at an intermediate position, referring to FIG. 22, the first motor 541 and the second motor 551 are each in a first circular region 5411 which uses a point on the second axis 105 as a center O, and the radius of the first circular region 5411 is less than or equal to 800 mm. The first circular region 5411 is within the paper surface in FIG. 22, that is, the radius of the first circular region 5411 is within the paper surface. Further, the radius of the first circular region 5411 is less than or equal to 650 mm. Further, the radius of the first circular region 5411 is less than or equal to 550 mm. Further, the radius of the first circular region 5411 is less than or equal to 400 mm. Further, the radius of the first circular region 5411 is less than or equal to 300 mm. The snow throwing member 52 is at the intermediate position, which refers to that the extension direction of the snow throwing member 52 is in the front and rear direction. In this way, the first motor 541 and the second motor 551 can drive the snow throwing member 52 and the deflector 51 more stably. In addition, the first motor 541 and the second motor 551 are located in an unoccupied region behind the snow throwing member 52 and the deflector 51, thereby saving a space and protecting the first motor 541 and the second motor 551. The snow throwing member 52 is located at the intermediate position, which refers to that the snow throwing member 52 shown in FIG. 1 faces the front of the snow blower. In this case, the snow throwing member 52 may throw the snow directly in front of the snow blower.

The distance from the center of gravity of the first motor 541 to the first axis 104 is greater than or equal to 40 mm and less than or equal to 100 mm. The second motor 551 is in a second circular region which uses a point on the second axis 105 as a center O, and the radius of the second circular region is greater than or equal to 25 mm and less than or equal to 75 mm.

The snow throwing system 50 further includes a support rod 53 extending along an up and down direction and used for supporting at least the first drive apparatus 54. A first end of the support rod 53 is fixed to the snow chimney 13 of the body housing 10, and the support rod 53 extends along the up and down direction to form a second end. The second end of the support rod 53 is fixedly mounted to the first drive apparatus 54. In some examples, the support rod 53 is constituted by a first rod portion 531 and a second rod portion 532. The first rod portion and the second rod portion are locked to each other by a locking assembly and constitute a detachable connection so that the snow throwing system 50 is detachable from the body 100, thereby facilitating transportation and saving a storage space.

The snow throwing system 50 further includes a housing for accommodating the first drive apparatus 54 and the second drive apparatus 55. In this example, the preceding housing is also referred to as a motor housing. The motor housing includes a first portion 561 and a second portion 562. The first portion 561 is fixedly mounted to the deflector 51 and can rotate relative to the second portion 562 about the second axis 105. Optionally, the second portion 562 is formed with a connection portion 5621, where the first portion 561 is slidably connected to the connection portion 5621 when the first portion 561 rotates relative to the second portion 562 about the second axis 105. The motor housing further includes a third portion, and the second portion 562 can rotate relative to the third portion about the first axis 104. The third portion includes a first upper housing 5631 and a first lower housing 5632. One end of the support rod 53 is connected to the snow chimney 13, and the other end of the support rod 53 is used for supporting the third portion of the motor housing. The snow throwing system 50 further includes a circuit board assembly 573. The circuit board assembly 573 is disposed in the accommodating space formed by the first upper housing 5631 and the first lower housing 5632. The snow throwing system 50 further includes an upper cover 5633 detachably connected to the first upper housing 5631 and used for sealing the circuit board assembly 573. In this way, when the circuit board assembly is faulty, the upper cover 5633 may be directly opened so that the circuit board assembly 573 is maintained.

Optionally, the first upper housing 5631 and the first lower housing 5632 form the accommodating space for accommodating at least part of the first drive apparatus 54 and at least part of the second drive apparatus 55. After the first upper housing 5631 and the first lower housing 5632 are assembled along the up and down direction, the first upper housing 5631 and the first lower housing 5632 are fastened and mounted by screws. The first portion 561 is rotatably connected to the second portion 562 and forms an accommodating space with the deflector 51, and the accommodating space is used for accommodating at least part of the second drive apparatus 55. In the process in which the first portion 561 rotates relative to the second portion 561 about the second axis 105, the connection portion 5621 is not separated from the first portion 561 so that it is ensured that the second drive apparatus 55 is always in the preceding accommodating space, thereby achieving a waterproof effect. The first portion 561 is rotatably connected to the second portion 562. When the deflector 51 rotates about the second axis 105, the first portion 561 is driven to rotate relative to the second portion 562.

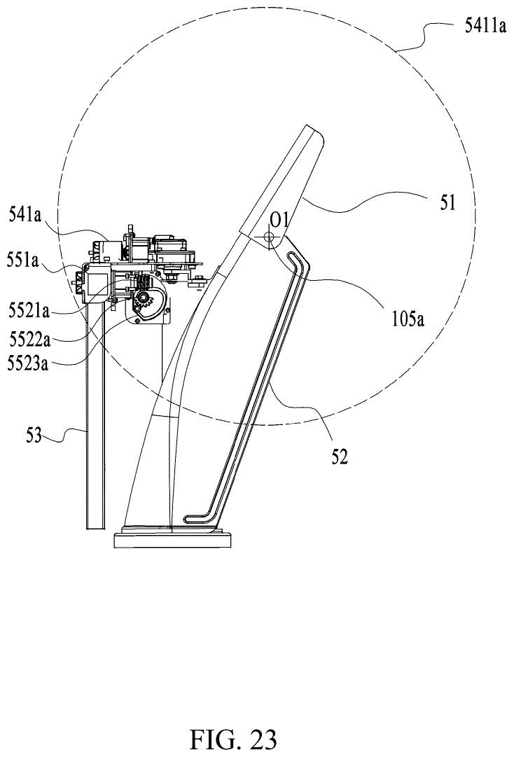

In another possible example, a first motor 541a and a second motor 551a are arranged as shown in FIG. 23. Different from the preceding example, the second motor 551a is disposed under the first motor 541a. The second motor 551a drives a worm shaft 5521a to rotate, the worm shaft 5521a drives a first worm gear 5522a to rotate, and the first worm gear 5522a drives a wire wheel 5523a to drive the deflector 51 to rotate about a second axis 105a. In this example, when the snow throwing member 52 is at an intermediate position, the first motor 541a and the second motor 551a are each in a first circular region 5411a which uses a point on the second axis 105a as a center O1, and the radius of the first circular region 5411a is less than or equal to 800 mm. Further, the radius of the first circular region 5411a is less than or equal to 650 mm. Further, the radius of the first circular region 5411a is less than or equal to 550 mm. Further, the radius of the first circular region 5411a is less than or equal to 400 mm. Further, the radius of the first circular region 5411a is less than or equal to 300 mm. The snow throwing member 52 is at the intermediate position, which refers to that the extension direction of the snow throwing member 52 is in the front and rear direction.

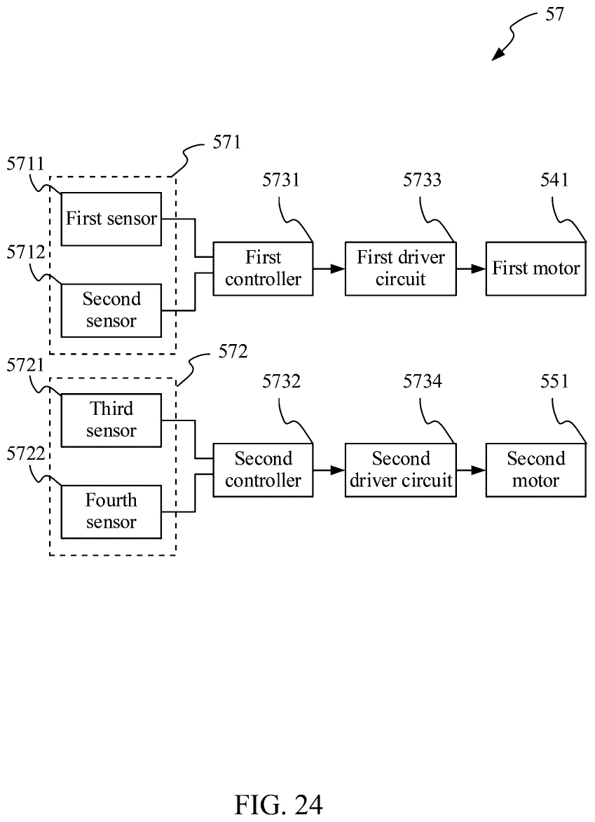

The snow throwing system 50 further includes a control apparatus 57. Referring to FIG. 24, the control apparatus 57 is configured to control the running state of the first drive apparatus 54 and the running state of the second drive apparatus 55. The control apparatus 57 includes an operation member disposed on the handle assembly 21, a first sensing apparatus, a second sensing apparatus, and the circuit board assembly 573. The preceding operation member may be understood as a second operation member 213. The circuit board assembly 573 is disposed on the first drive apparatus 54 and located in the accommodating space formed by the first upper housing 561 and the first lower housing 562.

The second operation member 213 is operated by the user and used for adjusting an angle by which the snow throwing member 52 rotates about the first axis 104 and an angle by which the deflector 51 rotates relative to the snow throwing member 52 about the second axis 105. Optionally, the second operation member 213 is configured to be a handle which can be held by the user. The user's hand can hold the handle to rotate the handle in the front and rear direction, rotate the handle in a left and right direction, or rotate the handle in the front and rear direction and the left and right direction at the same time. For example, the user controls the second operation member 213 to rotate forward and controls, at the same time, the second operation member 213 to rotate leftward. In this example, when the user operates the second operation member 213 to rotate leftward or rightward, the snow throwing member 52 correspondingly rotates leftward or rightward about the first axis 104. When the user operates the second operation member 213 to rotate forward or backward, the deflector 51 correspondingly rotates forward or backward about the second axis 105. Of course, another manner may be adopted for the second operation member 213.

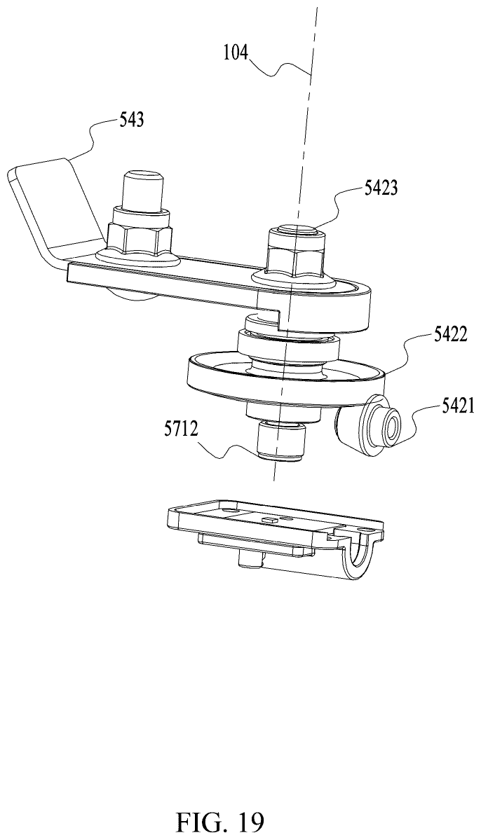

The first sensing apparatus is configured to detect an angle of the second operation member 213 in the left and right direction and an angle of the snow throwing member 52 in the left and right direction. In this example, the first sensing apparatus includes a first sensor 5711 and a second sensor 5712. Optionally, the first sensor 5711 is configured to detect the angle of the second operation member 213 in the left and right direction, and the second sensor 5712 is configured to detect the angle of the snow throwing member 52 in the left and right direction. Referring to FIG. 19, the second sensor 5712 is mounted to the first output shaft 5423.

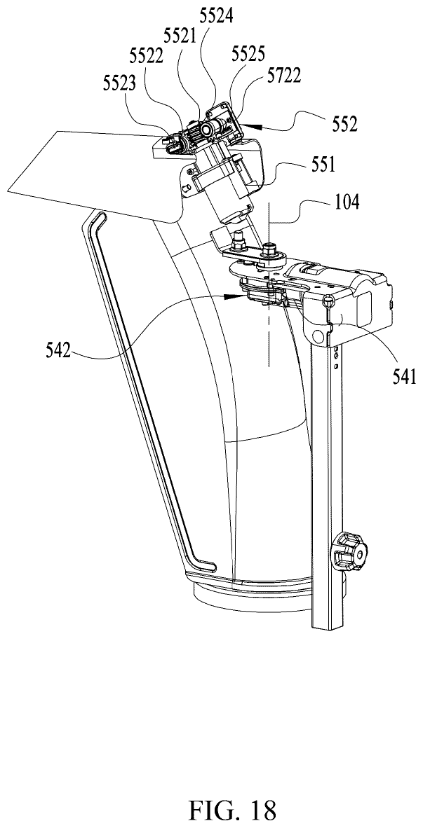

The second sensing apparatus is configured to detect an angle of the second operation member 213 in the front and rear direction and an angle of the deflector 51 in the up and down direction. In this example, the second sensing apparatus includes a third sensor 5721 and a fourth sensor 5722. Optionally, the third sensor 5721 is configured to detect the angle of the second operation member 213 in the front and rear direction, and the fourth sensor 5722 is configured to detect the angle of the deflector 51 in the up and down direction. Optionally, as shown in FIG. 18, the second transmission mechanism 552 further includes a second worm gear 5524 and a third output shaft 5525. The fourth sensor 5722 is disposed on the third output shaft 5525.

In the present application, the first sensor 5711, the second sensor 5712, the third sensor 5721, and the fourth sensor 5722 are configured to be Hall sensors. It is to be understood that other forms of sensors may be used as the first sensor 5711, the second sensor 5712, the third sensor 5721, and the fourth sensor 5722 mentioned above to acquire corresponding angles. Of course, the first sensor 5711, the second sensor 5712, the third sensor 5721, and the fourth sensor 5722 mentioned above may be one type of sensor or multiple types of sensors. Overall, in the present application, the types and the numbers of the first sensor 5711, the second sensor 5712, the third sensor 5721, and the fourth sensor 5722 mentioned above may be set according to an actual situation.

The circuit board assembly 573 includes at least a first controller 5731, a second controller 5732, a first driver circuit 5733 electrically connected to the first controller 5731, and a second driver circuit 5734 electrically connected to the second controller 5732. The first controller 5731 is configured to control the first driver circuit 5733 to drive the first motor 541 to run. The second controller 5732 is at least configured to control the second driver circuit 5734 to drive the second motor 551 to run. Optionally, the first driver circuit 5733 and the second driver circuit 5734 are configured to be three-phase bridge circuits. The first driver circuit 5733 includes three electronic switches provided as high-side switches and three electronic switches provided as low-side switches. Similarly, the second driver circuit 5734 also includes three electronic switches provided as high-side switches and three electronic switches provided as low-side switches. Since a specific circuit of the driver circuit is a general technique in the art, the details are not described here.

The first controller 5731 is electrically connected to the first sensor 5711 and the second sensor 5712 which are configured to acquire the angle of the second operation member 213 in the left and right direction and the angle of the snow throwing member 52 in the left and right direction, respectively. Optionally, the first controller 5731 acquires, in real time, a first electrical signal outputted by the first sensor 5711 and a second electrical signal outputted by the second sensor 5712 and controls the turn-on state of the first motor 541 based on the first electrical signal and the second electrical signal. Optionally, the first controller 5731 sets a preset second electrical signal based on the acquired first electrical signal and compares the preset second electrical signal with the preceding acquired second electrical signal. When the second electrical signal is different from the preset electrical signal, the first motor 541 is controlled to be started, and thus, the snow throwing member 52 is driven to rotate about the first axis 104 so that the angle of the snow throwing member 52 in the left and right direction corresponds to the angle of the second operation member 213 in the left and right direction. After the first motor 541 is started, the first controller 5731 acquires the first electrical signal and the second electrical signal in real time until the acquired second electrical signal is the preset second electrical signal, and the first motor 541 is controlled to be turned off after a period of time.

Optionally, the angle by which the second operation member 213 may rotate in the left and right direction ranges from about 0° to 80°, and the angle by which the snow throwing member 52 rotates about the first axis 104 ranges from about 0° to 200°. The angle of the snow throwing member 52 in the left and right direction corresponds to the angle of the second operation member 213 in the left and right direction, which may be understood as follows: when a current angle of the second operation member 213 is 0°, the angle of the snow throwing member 52 is set to 0°, when a current angle of the second operation member 213 is 40°, the angle of the snow throwing member 52 is set to 100°, when a current angle of the second operation member 213 is 80°, the angle of the snow throwing member 52 is set to 200°, and when a current angle of the second operation member 213 is 20°, the angle of the snow throwing member 52 is set to 50°.

In some working conditions, in the process in which the snow blower removes the snow, the snow throwing member 52 and the deflector 51 are subjected to the reaction force of the thrown snow. When the reaction force to which the snow throwing member 52 and the deflector 51 are subjected is relatively great, the first transmission mechanism 542 or the second transmission mechanism 552 may be driven to rotate, thereby damaging electronic components in the circuit board assembly 573. For the alleviation of the preceding problem, in this example, after the first motor 541 or the second motor 551 is controlled to be turned off, the three electronic switches as the low-side switches or the high-side switches of the first driver circuit 5733 are controlled to be turned on at the same time, and the three electronic switches as the low-side switches or the high-side switches of the second driver circuit 5734 are controlled to be turned on at the same time.

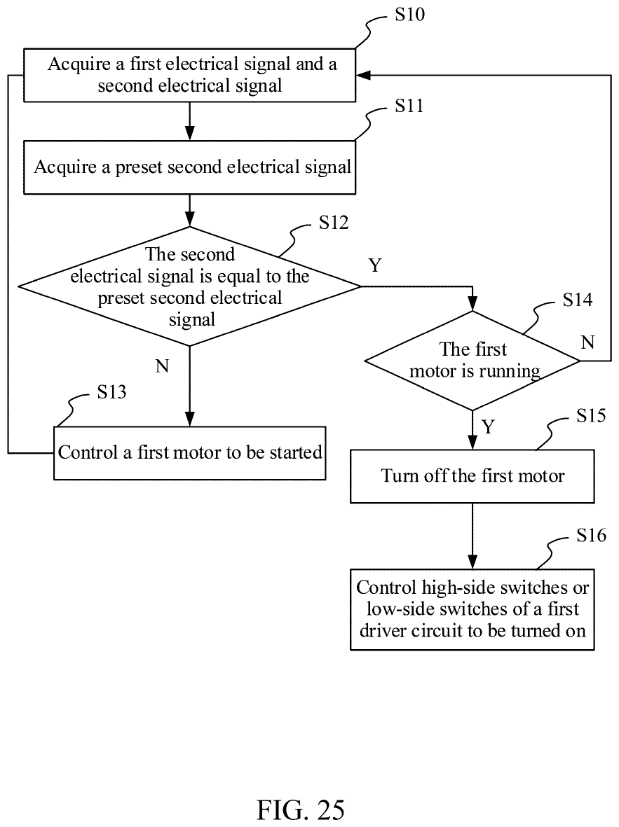

Next, referring to FIG. 25, a method for controlling the snow throwing member 52 of the snow throwing system 50 is described in detail. The method includes the steps below.

In S10, the first electrical signal outputted by the first sensor and the second electrical signal outputted by the second sensor are acquired.

In S11, the preset second electrical signal is acquired.

In S12, it is determined whether the second electrical signal is equal to the preset second electrical signal. If yes, step S14 is performed. If not, step S13 is performed.

In S13, the first motor is controlled to be started. Step S10 is performed.

In S14, it is determined whether the first motor is started. If yes, step S15 is performed. If not, step S10 is performed.

In S15, the first motor is turned off.

In S16, the three electronic switches as the high-side switches or the low-side switches of the first driver circuit are controlled to be turned on at the same time.

The second controller 5732 is electrically connected to the third sensor 5721 and the fourth sensor 5722 which are configured to acquire the angle of the second operation member 213 in the front and rear direction and the angle of the deflector 51 in the up and down direction, respectively. Optionally, the second controller 5732 acquires, in real time, a third electrical signal outputted by the third sensor 5721 and a fourth electrical signal outputted by the fourth sensor 5722 and controls the turn-on state of the second motor 551 based on the third electrical signal and the fourth electrical signal. Optionally, the second controller 5732 sets a preset fourth electrical signal based on the acquired third electrical signal and compares the preset fourth electrical signal with the preceding acquired fourth electrical signal. When the fourth electrical signal is different from the preset electrical signal, the second motor 551 is controlled to be started, and thus, the deflector 51 is driven to rotate about the second axis 105 so that the angle of the deflector 51 in the up and down direction corresponds to the angle of the second operation member 213 in the front and rear direction. After the second motor 551 is started, the second controller 5732 acquires the third electrical signal and the fourth electrical signal in real time until the acquired fourth electrical signal is the preset fourth electrical signal, and the second motor 551 is controlled to be turned off after a period of time.

Optionally, the angle by which the second operation member 213 may rotate in the front and rear direction ranges from about 0° to 50°, and the angle by which the deflector 51 rotates about the second axis 105 ranges from about 0° to 65°. The angle of the deflector 51 in the up and down direction corresponds to the angle of the second operation member 213 in the front and rear direction, which may be understood as follows: when a current angle of the second operation member 213 is 0°, the angle of the deflector 51 is set to 0°, when a current angle of the second operation member 213 is 50°, the angle of the deflector 51 is set to 65°, and when a current angle of the second operation member 213 is 10°, the angle of the deflector 51 is set to 13°.

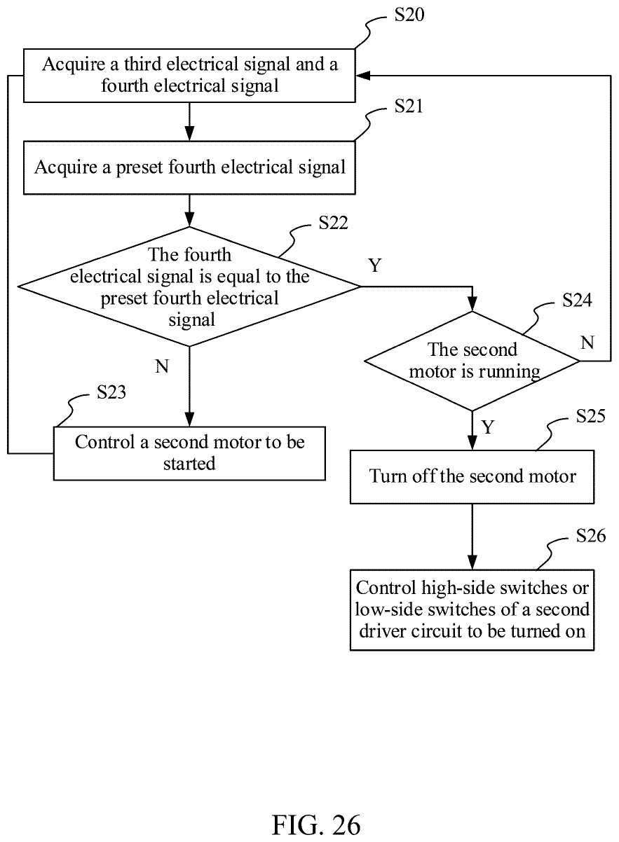

Next, referring to FIG. 26, a method for controlling the deflector 51 of the snow throwing system 50 is described in detail. The method includes the steps below.

In S20, the third electrical signal outputted by the third sensor and the fourth electrical signal outputted by the fourth sensor are acquired.

In S21, the preset fourth electrical signal is acquired.

In S22, it is determined whether the fourth electrical signal is equal to the preset fourth electrical signal. If yes, step S24 is performed. If not, step S23 is performed.

In S23, the second motor is controlled to be started. Step S20 is performed.

In S24, it is determined whether the second motor is started. If yes, step S25 is performed. If not, step S20 is performed.

In S25, the second motor is turned off.

In S26, the three electronic switches as the high-side switches or the low-side switches of the second driver circuit are controlled to be turned on at the same time.

It is to be noted that the control of the deflector 51 and the control of the snow throwing member 52 in this example are independent of each other, which may be understood as follows: the user may control the second operation member 213 to rotate in the front and rear direction and the left and right direction at the same time. In this case, the first controller 5731 controls the first driver circuit 5733 to drive the first motor 541 to run and is configured to control the snow throwing member 52 to rotate by a corresponding angle about the first axis 104, and the second controller 5732 controls the second driver circuit 5734 to drive the second motor 551 to run and is configured to control the deflector 51 to rotate by a corresponding angle about the second axis 105.

In this example, the first controller 5731 controls, based on the state of the second operation member 213, the first motor 541 to be started. Optionally, the first controller 5731 controls, based on the first electrical signal outputted by the first sensor 5711 of the first sensing apparatus 571 and the second electrical signal outputted by the second sensor 5712 of the first sensing apparatus 571, the first motor 541 to be started. After the first motor 541 is started, the first controller 5731 controls the first motor 541 to run at a first constant rotational speed and be configured to drive the snow throwing member 52 to rotate relative to the body 100 about the first axis 104. The second controller 5732 controls, based on the state of the second operation member 213, the second motor 551 to be started. Optionally, the second controller 5732 controls, based on the third electrical signal outputted by the third sensor 5721 of the second sensing apparatus 572 and the fourth electrical signal outputted by the fourth sensor 5722 of the second sensing apparatus 572, the second motor 551 to be started. After the second motor 551 is started, the second controller 5732 controls the second motor 551 to run at a second constant rotational speed and be configured to drive the deflector 51 to rotate relative to the snow throwing member 52 about the second axis 105. The second rotational speed is greater than or equal to the first rotational speed. It is to be understood that the first motor 541 or the second motor 551 runs at a constant speed in a running process and is independent of the rotational speed of the second operation member 213.

In some examples, after the snow blower is powered off, the angle of the second operation member 213 in the front and rear direction may not correspond to the angle of the deflector 51 in the up and down direction or the angle of the second operation member 213 in the left and right direction may not correspond to the angle of the snow throwing member 52 in the left and right direction due to the misoperation of the user. After the user powers on the snow blower, the first controller 5731 actively corrects the angle of the snow throwing member 52 so that the angle of the snow throwing member 52 corresponds to the angle of the second operation member 213 in the left and right direction. At the same time, the second controller 5732 actively corrects the angle of the deflector 51 so that the angle of the deflector 51 corresponds to the angle of the second operation member 213 in the front and rear direction.

In this example, after the snow blower is powered on, even if a current angle of the deflector 51 or a current angle of the snow throwing member 52 does not correspond to the angle of the second operation member 213, the first controller 5731 and the second controller 5732 do not actively adjust the angle of the snow throwing member 52 or the angle of the deflector 51. After the user operates the second operation member 213, the first controller 5731 or the second controller 5732 acquires, through the first sensing apparatus 571 or the second sensing apparatus 572, a first trigger signal or a second trigger signal outputted by the second operation member 213 and controls the corresponding motor to adjust the angle of the deflector 51 or the angle of the snow throwing member 52 so that the angle of the deflector 51 or the angle of the snow throwing member 52 corresponds to the current angle of the second operation member 213. It is to be understood that “after the snow blower is powered on” mentioned above should refer to “after the first controller 5731 or the second controller 5732 is powered on”. In this way, the security of the snow blower in a use process is improved, and the case is avoided where the snow throwing member 52 and the deflector 51 touch the body of the user in a rotation process, thereby causing harm to the user.

In a possible example, after the snow blower is powered on, the user may separately correct the angle of the deflector 51 and the angle of the snow throwing member 52 according to the choice of the user. Optionally, the user first corrects the angle of the deflector 51 and then corrects the angle of the snow throwing member 52. Optionally, the user first corrects the angle of the snow throwing member 52 and then corrects the angle of the deflector 51.

When the user chooses to correct the angle of the snow throwing member 52, the user operates the second operation member 213 to rotate by a first preset angle leftward or rightward. In this case, the first controller 5731 acquires, through the first sensing apparatus 571, the first trigger signal outputted by the second operation member 213. After acquiring the first trigger signal, the first controller 5731 acquires a first angle of the second operation member 213 in the left and right direction and a second angle of the snow throwing member 52 in the left and right direction through the first sensing apparatus 571 and controls the turn-on state of the first motor 541 based on the first angle and the second angle. The range of the first preset angle is set to 5° to 10°. Optionally, when the second angle corresponds to the first angle, the first controller 5731 controls the first motor 541 not to be started, and when the second angle does not correspond to the first angle, the first controller 5731 controls the first motor 541 to be started and drives the snow throwing member 52 to rotate about the first axis 104 so that the current angle of the snow throwing member 52 corresponds to the first angle of the second operation member 213.

When the user chooses to correct the deflector 51, the user operates the second operation member 213 to rotate by a second preset angle forward or backward. In this case, the second controller 5732 acquires, through the second sensing apparatus 572, the second trigger signal outputted by the second operation member 213. After acquiring the second trigger signal, the second controller 5732 acquires a third angle of the second operation member 213 in the front and rear direction and a fourth angle of the deflector 51 in the up and down direction through the second sensing apparatus 572 and controls the turn-on state of the second motor 551 based on the third angle and the fourth angle. The range of the second preset angle is set to 5° to 10°. Optionally, when the third angle corresponds to the fourth angle, the second controller 5732 controls the second motor 551 not to be started, and when the third angle does not correspond to the fourth angle, the second controller 5732 controls the second motor 551 to be started and drives the deflector 51 to rotate about the second axis 105 so that the current angle of the deflector 51 corresponds to the third angle of the second operation member 213.

It is to be noted that the correspondence between the angle of the second operation member 213 in the left and right direction and the angle of the snow throwing member 52 in the left and right direction and the correspondence between the angle of the second operation member 213 in the up and down direction and the angle of the deflector 51 in the up and down direction have been described above in detail. The details are not repeated here.

In another possible example, the user operates the second operation member 213 to output the first trigger signal and the second trigger signal at the same time. After acquiring the first trigger signal, the first controller 5731 corrects the angle of the snow throwing member 52.

After acquiring the second trigger signal, the second controller 5732 corrects the angle of the deflector 51. Optionally, the second operation member 213 outputs the first trigger signal and the second trigger signal at the same time, which refers to that the user operates the second operation member 213 to rotate in the front and rear direction and the left and right direction at the same time.

In other examples, the operation assembly 200 further includes a trigger apparatus configured to output a trigger signal. A difference between the preceding example and this example lies in that the trigger signal in the preceding example is outputted by the second operation member and the trigger signal in this example is outputted by the trigger apparatus. Of course, the trigger apparatus may be optionally configured to be a button or a switch or configured to be in another form. The trigger apparatus may be optionally mounted on or near the second operation member. Of course, the trigger apparatus may be mounted at another position.

After the snow blower is powered on, the user needs to operate the trigger apparatus to output the trigger signal. After acquiring the trigger signal, a control unit controls, according to the current actual situation of the deflector and the current actual situation of the snow throwing member, the first motor and the second motor to be started. The preceding actual situation of the deflector and the preceding actual situation of the snow throwing member refer to whether the current angle of the deflector corresponds to the angle of the second operation member in the front and rear direction and whether the current angle of the snow throwing member corresponds to the angle of the second operation member in the left and right direction.

Optionally, the control unit may acquire the trigger signal in different manners. In some examples, the control unit includes a first controller and a second controller. The first controller can acquire the first angle of the second operation member and the second angle of the snow throwing member through the first sensing apparatus. The second controller can acquire the third angle of the second operation member and the fourth angle of the deflector through the second sensing apparatus. The trigger apparatus is electrically connected to the first controller or the second controller at the same time. After the user presses the trigger apparatus, the first controller and the second controller receive, at the same time, trigger signals outputted by the trigger apparatus and start the corresponding first motor or the corresponding second motor according to the current actual situation of the deflector and the current actual situation of the snow throwing member.

In other examples, the control unit includes a first controller, a second controller, and a third controller. The first controller can acquire the first angle of the second operation member and the second angle of the snow throwing member through the first sensing apparatus. The second controller can acquire the third angle of the second operation member and the fourth angle of the deflector through the second sensing apparatus. The third controller is connected to the trigger apparatus and configured to acquire the trigger signal outputted by the trigger apparatus. Optionally, the third controller is electrically connected to the first controller and the second controller separately. After the third controller acquires the trigger signal, the first controller controls, based on the first angle and the second angle, the first motor to run so that the second angle corresponds to the first angle. At the same time, the second controller controls, based on the third angle and the fourth angle, the second motor to run so that the fourth angle corresponds to the third angle.

What is claimed is:

1. A snow blower, comprising:
a body; and
an operation assembly connected to the body and configured to allow an operator to guide and control the snow blower;
wherein the body comprises a snow throwing system, the snow throwing system comprises a snow throwing member, a deflector connected to the snow throwing member and disposed on the snow throwing member, a first motor configured to drive the snow throwing member to rotate relative to the body about a first axis, and a second motor configured to drive the deflector to rotate relative to the snow throwing member about a second axis, and, when the snow throwing member is at an intermediate position, the first motor and the second motor are each in a first circular region which uses a point on the second axis as a center and a radius of the first circular region is less than or equal to 800 mm.

2. The snow blower according to claim 1, wherein the body further comprises a snow removal housing and a support rod extending substantially along an up and down direction, and one end of the support rod is connected to the snow removal housing and another end of the support rod is used for supporting the first motor.

3. The snow blower according to claim 2, wherein the support rod comprises a first rod portion and a second rod portion which constitute a detachable connection, and the first rod portion and the second rod portion are detachably connected to each other so that the snow throwing system is detachable relative to the snow removal housing.

4. The snow blower according to claim 2, wherein the first motor and the second motor are each disposed at an upper end of the support rod.

5. The snow blower according to claim 1, wherein the body further comprises a first transmission mechanism comprising at least a first gear and a second gear, the first motor drives the first gear to rotate, the first gear drives the second gear to rotate, and the first gear and the second gear are configured to be bevel gears.

6. The snow blower according to claim 5, wherein the first transmission mechanism further comprises a first output shaft, and the second gear drives the first output shaft to rotate about the first axis.

7. The snow blower according to claim 6, wherein the first output shaft is further connected to a rotating member, one end of the rotating member is sleeved on the first output shaft and driven by the first output shaft and another end of the rotating member is fixedly connected to the snow throwing member and is used for driving the snow throwing member to rotate about the first axis.

8. The snow blower according to claim 1, wherein the body further comprises a second transmission mechanism comprising at least a worm gear and a worm shaft, the second motor drives the worm shaft to drive the worm gear to rotate about the second axis, and the worm gear drives the deflector to rotate about the second axis.

9. The snow blower according to claim 1, wherein a distance from a center of gravity of the first motor to the first axis is greater than or equal to 40 mm and less than or equal to 100 mm.

10. The snow blower according to claim 9, wherein the second motor is in a second circular region which uses the second axis as a center, and a radius of the second circular region is greater than or equal to 25 mm and less than or equal to 75 mm.

11. The snow blower according to claim 1, wherein the body further comprises a motor housing, the first motor and the second motor are disposed in the motor housing, the motor housing comprises a first portion, a second portion, and a third portion, and the first portion is fixedly mounted to the deflector.

12. The snow blower according to claim 11, wherein the deflector drives the first portion to rotate relative to the second portion about the second axis when the second motor drives the deflector to rotate about the second axis.

13. The snow blower according to claim 1, wherein the operation assembly comprises at least an operation member configured to control the first motor or the second motor to run, the operation member is provided with a handle, and a user is capable of operating the handle to rotate in a front and rear direction and a left and right direction so as to control the snow throwing member to rotate about the first axis in the left and right direction and the deflector to rotate about the second axis in an up and down direction.

14. The snow blower according to claim 1, further comprising an operation member configured to be operated by a user to control the first motor and a first controller electrically connected to at least the first motor and configured to control the first motor to run, wherein the first controller is configured to control, based on a state of the operation member, the first motor to run to drive the snow throwing member to rotate at a constant speed relative to the body about the first axis.

15. The snow blower according to claim 1, further comprising an operation member configured to be operated by a user to control the second motor and a second controller electrically connected to at least the second motor and configured to control the second motor to run, wherein the second controller is configured to, after the second motor is started, control the second motor to run at a constant speed to drive the deflector to rotate relative to the snow throwing member about the second axis.

16. A snow blower, comprising:
a body; and
an operation assembly connected to the body and configured to allow an operator to guide and control the snow blower;
wherein the body comprises a snow throwing system, the snow throwing system comprises a snow throwing member, a deflector connected to the snow throwing member and disposed on the snow throwing member, a first motor configured to drive the snow throwing member to rotate relative to the body about a first axis, a second motor configured to drive the deflector to rotate relative to the snow throwing member about a second axis, and a support rod, a lower end of the support rod is connected to a snow removal housing, an upper end of the support rod supports a first motor, and the first motor and the second motor are each disposed at the upper end of the support rod.

17. The snow blower according to claim 16, wherein the support rod comprises a first rod portion and a second rod portion which constitute a detachable connection, and the first rod portion and the second rod portion are detachable so that the snow throwing system is relatively detachable.

18. A snow blower, comprising:
a body; and
an operation assembly connected to the body and comprising at least an operation member;
wherein the body comprises a snow throwing member, a deflector connected to the snow throwing member and disposed on the snow throwing member, a first motor configured to drive the snow throwing member to rotate relative to the body about a first axis, a second motor configured to drive the deflector to rotate relative to the snow throwing member about a second axis, and a first controller electrically connected to at least the first motor and configured to control the first motor to run, and the first controller is configured to control, based on a state of the operation member, the first motor to run to drive the snow throwing member to rotate at a constant speed relative to the body about the first axis.

19. The snow blower according to claim 18, further comprising a second controller electrically connected to at least the second motor and configured to control the second motor to run, wherein the second controller is configured to, after the second motor is started, control the second motor to run at a constant speed to drive the deflector to rotate relative to the snow throwing member about the second axis.

20. The snow blower according to claim 18, wherein the operation member is provided with a handle, and a user is capable of operating the handle to rotate in a front and rear direction and a left and right direction so as to control the snow throwing member to rotate about the first axis in the left and right direction and the deflector to rotate about the second axis in an up and down direction.
